(19) United States
(12) Patent Application Publication
(10) Pub. No.: US 2012/0081356 A1
(43) Pub. Date: Apr. 5, 2012

(54) METHODS AND APPARATUS FOR RENDERING APPLICATIONS AND WIDGETS ON A MOBILE DEVICE INTERFACE IN A THREE-DIMENSIONAL SPACE

(76) Inventors: Vasily Filippov, Saint-Petersburg (RU); Yaroslav Goncharov, Sosnovy Bor (RU)

(21) Appl. No.: 12/896,139

(22) Filed: Oct. 1, 2010

(51) Int. Cl. G06T 15/00

(52) U.S. Cl. 345/419

(57) ABSTRACT

A system represents each of the available applications, including widgets, with a respective image representation on a display associated with the communications device. The system associates each of the image representations with a respective subset of image representations, or panels that are organized to assist a user to locate and interact with the image representations. The system arranges the panels in a three dimensional structure, on the display. The three dimensional structure is rendered as a plurality of joined adjacent panels. The system allows the user to access an available application within the three dimensional structure by manipulating the three dimensional structure three dimensionally where the available application are accessed via the respective panel.

### CROSS REFERENCE TO RELATED APPLICATIONS

This application relates to the following applications filed on the same date as the present application:

i) “METHODS AND APPARATUS FOR RENDERING A MOBILE DEVICE INTERFACE IN A CAROUSEL”, Filed Dec. 18, 2009, Attorney Docket Number SPB09-01

ii) “METHODS AND APPARATUS FOR ORGANIZING A COLLECTION OF WIDGETS ON A MOBILE DEVICE DISPLAY”, Filed Feb. 5, 2010, Attorney Docket Number SPB09-02

iii) “METHODS AND APPARATUS FOR RENDERING A COLLECTION OF WIDGETS ON A MOBILE DEVICE DISPLAY”, Filed Feb. 5, 2010, Attorney Docket Number SPB09-05

iv) “METHODS AND APPARATUS FOR ORGANIZING AND RENDERING A COLLECTION OF WIDGETS ON A MOBILE DEVICE DISPLAY”, Filed Feb. 10, 2010, Attorney Docket Number SPB09-10

v) “METHODS AND APPARATUS FOR ORGANIZING APPLICATIONS AND WIDGETS ON A MOBILE DEVICE INTERFACE”, Filed Oct. 1, 2010, Attorney Docket Number SPB10-05

The teachings and disclosure of the above co-filed applications are each incorporated by reference herein in their entirety.

### BACKGROUND

Smart phones are mobile phones with PC like features, including an operating system, software applications, a miniature QWERTY keyboard, touch screen, etc. Smart phones run various software applications, such as email clients, and provide Internet access. Given the size of the touch screen, only a subset of the available application can be rendered on the touch screen at any given time. Users advance through additional available software applications by sliding their finger along the touch screen, and/or tapping the touch screen. This movement modifies which subset of applications is displayed on the screen, sliding some of the displayed available applications off the touch screen and displaying other available applications. Smart phone users access various software applications via the touch screen (i.e., tapping the touch screen invokes the selected software application). In other words, users slide their finger along the screen to view the available software applications. Icons and widgets displayed on the touch screen represent the available software applications. When the desired software application is rendered on the screen, the user taps the touch screen at the location of the icon to invoke that application.

### SUMMARY

Conventional computerized technologies for displaying available applications (including widgets) on a communications device, such as a smart phone, suffer from a variety of deficiencies. In particular, conventional technologies for displaying available applications are limited in that conventional technologies only allow users to access the available applications in only one or two dimensions. Conventional technologies often provide a hierarchy of screens requiring a user to navigate through these screens to reach the application the user wishes to access. Users must learn how to operate the communications device before they can fully utilize all the features of the communications device. Because of this, the task of learning how to use the communications device may present a barrier for some users.

Embodiments disclosed herein significantly overcome such deficiencies and provide a system that includes a computer system and/or software executing a three dimensional structure rendering and executing process that renders a three dimensional structure of available applications on the display of the communications device, allowing a user to access the available applications (including widgets) on the communications device. The three dimensional structure rendering and executing process represents each of the available applications with a respective image representation on a display that is associated with the communications device. In other words, each application is represented on the display by an icon. The icon may be a widget, a shortcut, a folder containing a plurality of icons, etc. The user may select the icon to launch the application. The user may also interact with the icon, for example, if the icon is a widget. The three dimensional structure rendering and executing process associates each of the image representations with a respective subset of image representations. The subsets of image representations are organized to assist a user to locate and interact with the image representations. In other words, by arranging the image representations in organized subsets, the user is quickly able to locate the image representations associated with the application that the user wishes to access.

The three dimensional structure rendering and executing process arranges the subsets of image representations in a three dimensional structure, three dimensionally, on the display. The three dimensional structure is rendered as a plurality of joined adjacent panels where each of the subset of image representations is represented in a respective panel. In effect, the subsets of image representations are the panels/screens/pages of the three dimensional structure that the user interacts with on the display. Within the three dimensional structure, at least one of the subsets of the image representations is visible in the front of the three dimensional structure concurrently with another subset of the image representations that is visible in the back of the three dimensional structure (for example, in a carousel formation), where the three dimensional structure is comprised of both of these subsets of image representations. In other words, when the user views the three dimensional structure on the display, the user can see some of the panels in the front of the three dimensional structure while also seeing some of the panels in the back of the three dimensional structure at the same time.

The three dimensional structure rendering and executing process allows the user to access an available application within the three dimensional structure by manipulating the three dimensional structure three dimensionally where the available application is accessed via the respective subset of image representations. In other words, the user drags a finger across the display to rotate or ‘spin’ the three dimensional structure on the display. The user may ‘spin’ the three dimensional structure to view the panels (i.e., the subsets of image representations) on the communications device. To spin the three dimensional structure, the user simply slides a finger across the display of the communications device, and the three dimensional structure rendering and executing process spins the three dimensional structure on the display. As the three dimensional structure spins, the panels are rendered on the display. When the user wishes to access a particular application the user taps on the panel (i.e., the subset of image representations) containing that application, and the user is able to interact with that panel to access the application by interacting with the image representation associated with that application.

In an example embodiment, the three dimensional structure rendering and executing process renders the panels (i.e., the subsets of image representations) in the back of the three dimensional structure as mirror images. When a user rotates the three dimensional structure to move those panels from the back of the three dimensional structure to the front of the three dimensional structure, the three dimensional structure rendering and executing process renders those panels as non-mirror images. If the user then rotates those panels from the front of the three dimensional structure to the back of the three dimensional structure, the three dimensional structure rendering and executing process will, once again, render those panels as minor images. In an example embodiment, each panel is transparent (i.e., capable of being viewed from either the back or the front of the panel). Thus, as the three dimensional structure is rotated, the user is viewing the back of those transparent panels, and the panels appear as minor images when rendered in the back of the three dimensional structure.

In an example embodiment, the three dimensional structure rendering and executing process renders the three dimensional structure with a three dimensional graphic positioned along with the three dimensional structure on the display. In another example embodiment, the three dimensional graphic may be animated. The three dimensional structure rendering and executing process positions the graphic proportionally to a relative change in the position of the three dimensional structure when the user manipulates the three dimensional structure (for example, a carousel formation). When the three dimensional structure rendering and executing process receives notification that the user has modified the position of the three dimensional structure on the display, in response, the three dimensional structure rendering and executing process simultaneously modifies the spatial position of the graphic to maintain an orientation of the graphic with respect to the relative change in the position of the three dimensional structure. In other words, as the user manipulates the three dimensional structure on the display, the three dimensional structure rendering and executing process positions the graphic according to the movement of the three dimensional structure so that when the user moves the three dimensional structure, the three dimensional structure rendering and executing process moves the graphic accordingly. Thus, the user maintains an orientation of the three dimensional structure by the positioning of the graphic with respect to the three dimensional structure on the display. If the user is looking at the front of the three dimensional structure, the user also sees the front of the graphic. If the user is looking at the back of the three dimensional structure, the user also sees the back of the graphic. In another example embodiment, the three dimensional structure rendering and executing process modifies the size of the rendering of the graphic on the display so that the size proportional to at least one subset of image representations rendered on the display. For example, as the user moves the view of the three dimensional structure to a close up view of a particular panel (i.e., a subset of image representations), the three dimensional structure rendering and executing process enlarges the size of the graphic so that the size of the graphic remains proportional to the size of the panel rendered on the display. In another example embodiment, the three dimensional structure rendering and executing process renders the graphic on the display when a panel is rendered in a close up view on the display. The close up view allows the user to interact with the image representations. In an example embodiment, the panel is rendered with a degree of transparency, and the user can see the graphic through the transparency of the panel. The graphic is rendered to orient the user to a position associated with the panel (i.e., the subset of image representations) within the three dimensional structure. If the panel rendered on the display is positioned in the front of the three dimensional structure, then the user sees the front of the graphic through the transparency of the panel. If the panel rendered on the display is positioned in the back of the three dimensional structure, then the user sees the back of the graphic through the transparency of the panel.

In an example embodiment, the three dimensional structure rendering and executing process allows the user to rotate the three dimensional structure on the display to view the panels (i.e., the subsets of image representations). The three dimensional structure rendering and executing process receives a selection of a chosen panel from the user, and renders the chosen panel on the display to allow the user to interact with the image representations associated with the chosen panel. The three dimensional structure rendering and executing process provides a mechanism to allow the user to toggle between the three dimensional structure of panels and any single panel. Thus, when a user is interacting with a single panel, the user can perform an action that switches the display from a rendering of the single panel to a rendering of the three dimensional structure. In another example embodiment, the three dimensional structure rendering and executing process renders the chosen panel with a degree of transparency that allows a portion of the remaining subsets of image representations to remain visible on the display. In other words, while the user is interacting with a chosen panel in a close up view, due to the transparency associated with that panel, the user is able to view the formation of the three dimensional structure through the transparency.

In example embodiment, the three dimensional structure rendering and executing process renders the chosen panel in a close up view on the display to facilitate the user's interaction with the image representations. In other words, the three dimensional structure rendering and executing process changes the view on the display from a view of the three dimensional structure (i.e., three dimensional structure view) to a close up view of a single panel (i.e., close up view). In another example embodiment, the three dimensional structure rendering and executing process receives notification that the user desires to view additional information. The three dimensional structure rendering and executing process then renders the chosen panel at a distanced view on the display. In the distanced view, the user may see one or two individual panels in the formation of a three dimensional structure rendered on the display. Within the distanced view, the user is able to see more of any information associated with the panel, for example, the user may see a title bar at the top of the panel. The title bar provides the user with additional information about the image representations rendered on that panel. For example, if the title bar displays ‘Favorite Contact’, this enables the user to easily and quickly identify which types of image representations are rendered on that panel. The user may access this additional information in a variety of ways. For example, if the user is viewing a panel in the close up view, the user may begin to scroll from the panel rendered on the display to the next adjacent panel within the three dimensional structure. In response to this action from the user, the three dimensional structure rendering and executing process switches from the close up view of the panel to a distanced view and maintains the three dimensional structure on the display to orient the user to the organization of the panels. In other words, within the distanced view, the user still sees the three dimensional structure rendered on the display, but within the distanced view, the user only sees one or two panels of the three dimensional structure. If the panels are rendered with a degree of transparency, the user may also view additional panels within the three dimensional structure through the transparency of the panels rendered on the display in the distanced view. In other words, the user may see other panels in the background through the transparency of the panels rendered within the distanced view.

In an example embodiment, the three dimensional structure rendering and executing process allows the user to manipulate the three dimensional structure of panels (i.e., the subsets of image representations) within the distanced view on the display. When the panels are rendered within the distanced view, the three dimensional structure rendering and executing process may receive a selection of a panel rendered on the display. In response, the three dimensional structure rendering and executing process renders the panel in the close up view on the display to facilitate the user's interaction with the image representations. In another example embodiment, the three dimensional structure rendering and executing process allows the user to interact with at least one panel (i.e., a subset of image representations) within the distanced view on the display.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by SPB Software, Inc. of Carson City, Nev., USA.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows an example three dimensional screen shot of a three dimensional structure on the display of a communications device.

FIG. 3 shows an example three dimensional screen shot of a tilted three dimensional structure on the display of a communications device.

FIG. 4 shows an example three dimensional screen shot of a three dimensional structure with a three dimensional graphic positioned along with the three dimensional structure on the display of a communications device.

FIG. 5 shows an example distanced view of a three dimensional screen shot of a three dimensional structure with a three dimensional graphic positioned with the three dimensional structure on the display of a communications device.

FIG. 6 shows an example close up view of a three dimensional screen shot of a panel of the three dimensional structure rendered with a three dimensional graphic on the display of a communications device.

FIG. 7 shows an example close up view of a three dimensional screen shot of a panel of the three dimensional structure on the display of a communications device.

FIG. 8 shows an example close up view of a three dimensional screen shot of a panel of the three dimensional structure rendered with a three dimensional graphic oriented to the three dimensional structure on the display of a communications device.

FIG. 9 shows an example distanced view of a three dimensional screen shot of two panels of the three dimensional structure on the display of a communications device.

FIG. 10 shows an example distanced view of a three dimensional screen shot of two panels of the three dimensional structure rendered with a graphic on the display of a communications device.

FIG. 11 shows an example close up view of a three dimensional screen shot of two panels of the three dimensional structure on the display of a communications device.

FIG. 12 shows an example close up view of a three dimensional screen shot of a panel of the three dimensional structure as the user begins to transition from a close up view to a three dimensional structure view on the display of a communications device.

FIG. 13 shows an example screen shot of the three dimensional structure during the transition from a close up view to a three dimensional structure view on the display of a communications device.

FIG. 14 shows an example screen shot of the three dimensional structure during the transition from a close up view to a three dimensional structure view as the three dimensional structure begins to take shape on the display of a communications device.

FIG. 15 shows an example screen shot of the three dimensional structure during the transition from a close up view to a three dimensional structure view as the formation of the three dimensional structure nears completion on the display of a communications device.

FIG. 16 shows an example screen shot of the completed three dimensional structure on the display of a communications device.

FIG. 17 shows an example screen shot of two panels each with a degree of transparency rendered along with a three dimensional graphic on the display of a communications device.

FIG. 18 shows an example screen shot of a three dimensional structure rendered along with a three dimensional graphic on the display of a communications device.

FIG. 19 shows example screen shot of a close up view of a panel rendered with a degree of transparency, and rendered along with a three dimensional graphic on the display of a communications device.

FIG. 20 illustrates a flowchart of a procedure performed by the system of FIG. 1, when the three dimensional structure rendering and executing process represents each of the available applications with a respective image representation on a display associated with the communications device, according to one embodiment disclosed herein.

FIG. 21 illustrates a flowchart of a procedure performed by the system of FIG. 1, when the three dimensional structure rendering and executing process arranges the subsets of image representations in a three dimensional structure, three dimensionally on the display, according to one embodiment disclosed herein.

FIG. 22 illustrates a flowchart of a procedure performed by the system of FIG. 1, when the three dimensional structure rendering and executing process renders the three dimensional structure with a three dimensional graphic positioned along with the three dimensional structure on the display, according to one embodiment disclosed herein.

FIG. 23 illustrates a flowchart of a procedure performed by the system of FIG. 1, when the three dimensional structure rendering and executing process positions the graphic proportionally to a relative change in a position of the three dimensional structure when the three dimensional structure is manipulated by the user, according to one embodiment disclosed herein.

FIG. 24 illustrates a flowchart of a procedure performed by the system of FIG. 1, when the three dimensional structure rendering and executing process allows the user to access an available application within the three dimensional structure by manipulating the three dimensional structure three dimensionally, according to one embodiment disclosed herein.

FIG. 25 illustrates a flowchart of a procedure performed by the system of FIG. 1, when the three dimensional structure rendering and executing process renders the chosen subset of image representations on the display to allow the user to interact with the image representations associated with the chosen subset of image representations, according to one embodiment disclosed herein.

FIG. 26 illustrates a flowchart of a procedure performed by the system of FIG. 1, when the three dimensional structure rendering and executing process allows the user to manipulate the three dimensional structure of subsets of image representations within the distanced view on the display, according to one embodiment disclosed herein.

FIG. 27 illustrates a flowchart of a procedure performed by the system of FIG. 1, when the three dimensional structure rendering and executing process receives notification that the user desires to view additional information, according to one embodiment disclosed herein.

FIG. 28 illustrates a flowchart of a procedure performed by the system of FIG. 1, when the three dimensional structure rendering and executing process renders the chosen subset of image representations at a distanced view on the display, according to one embodiment disclosed herein.

FIG. 29 illustrates a flowchart of a procedure performed by the system of FIG. 1, when the three dimensional structure rendering and executing process arranges the subsets of image representations in a three dimensional structure such as a carousel, on the display, according to one embodiment disclosed herein.

### DETAILED DESCRIPTION

Embodiments disclosed herein include a computer system executing a three dimensional structure rendering and executing process that renders a three dimensional structure of available applications on the display of the communications device, allowing a user to access the available applications (including widgets) on the communications device. The three dimensional structure rendering and executing process represents each of the available applications with a respective image representation on a display that is associated with the communications device. In other words, each application is represented on the display by an icon. The user may select the icon to launch the application. The three dimensional structure rendering and executing process associates each of the image representations with a respective subset of image representations. The subsets of image representations or panels are organized to assist a user to locate and interact with the image representations. In other words, by arranging the image representations in organized subsets, the user is quickly able to locate the image representations associated with the application the user wishes to access.

The three dimensional structure rendering and executing process arranges the subsets of image representations in a three dimensional structure, three dimensionally, on the display. The three dimensional structure is rendered as a plurality of joined adjacent panels where each of the subset of image representations is represented in a respective panel. In effect, the subsets of image representations are the panels/screens/pages of the three dimensional structure that the user interacts with on the display. Within the three dimensional structure, at least one of the subsets of the image representations is visible in the front of the three dimensional structure concurrently with another subset of the image representations that is visible in the back of the three dimensional structure, where the three dimensional structure is comprised of both of these subsets of image representations. In an example embodiment, the three dimensional structure may be in a carousel formation.

The three dimensional structure rendering and executing process allows the user to access an available application within the three dimensional structure by manipulating the three dimensional structure three dimensionally where the available application is accessed via the respective subset of image representations. To spin the three dimensional structure, the user simply slides a finger across the display of the communications device, and the three dimensional structure rendering and executing process spins the three dimensional structure on the display. As the three dimensional structure spins, the panels are rendered on the display. When the user wishes to access a particular application the user taps on the panel (i.e., the subset of image representations) containing that application, and the user is able to interact with that panel to access the application by interacting with the image representation associated with that application.

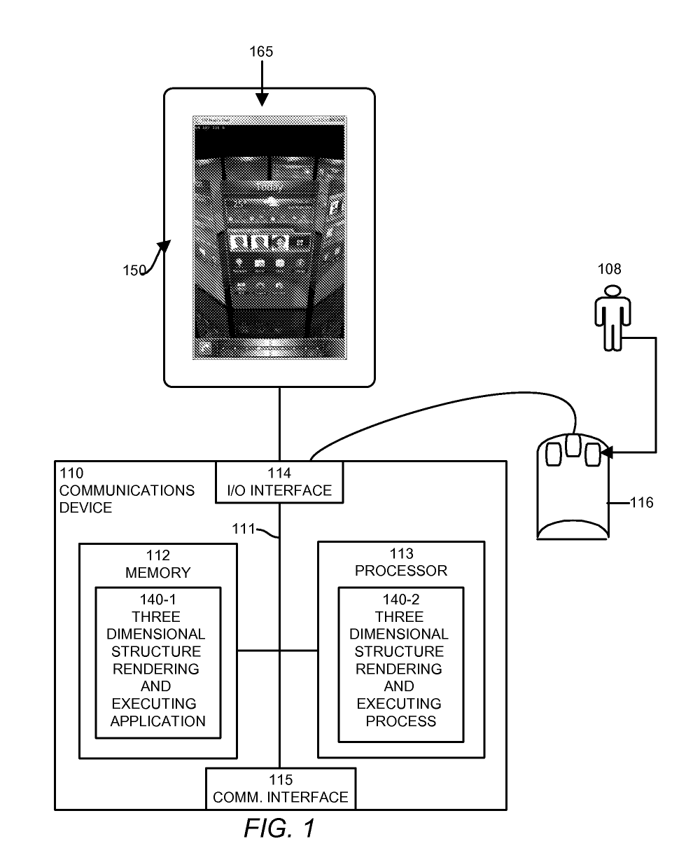

FIG. 1 is a block diagram illustrating example architecture of a communications device 110 that executes, runs, interprets, operates or otherwise performs a three dimensional structure rendering and executing application 140-1 and three dimensional structure rendering and executing process 140-2 suitable for use in explaining example configurations disclosed herein. The communications device 110 may be any type of computerized device such as a personal computer, workstation, portable computing device, console, laptop, network terminal or the like. An input device 116 (e.g., one or more user/developer controlled devices such as a keyboard, mouse, touch screen, etc.) couples to processor 113 through I/O interface 114, and enables a user 108 to provide input commands, and generally control a graphical user interface that the three dimensional structure rendering and executing application 140-1 and process 140-2 provides on the display 150 (rendering the three dimensional structure 165). As shown in this example, the communications device 110 includes an interconnection mechanism 111 such as a data bus or other circuitry that couples a memory system 112, a processor 113, an input/output interface 114, and a communications interface 115. The communications interface 115 enables the communications device 110 to communicate with other devices (i.e., other computers) on a network (not shown).

The memory system 112 is any type of computer readable medium, and in this example, is encoded with a three dimensional structure rendering and executing application 140-1 as explained herein. The three dimensional structure rendering and executing application 140-1 may be embodied as software code such as data and/or logic instructions (e.g., code stored in the memory or on another computer readable medium such as a removable disk) that supports processing functionality according to different embodiments described herein. During operation of the communications device 110, the processor 113 accesses the memory system 112 via the interconnect 111 in order to launch, run, execute, interpret or otherwise perform the logic instructions of a three dimensional structure rendering and executing application 140-1. Execution of a three dimensional structure rendering and executing application 140-1 in this manner produces processing functionality in three dimensional structure rendering and executing process 140-2. In other words, the three dimensional structure rendering and executing process 140-2 represents one or more portions or runtime instances of a three dimensional structure rendering and executing application 140-1 (or the entire a three dimensional structure rendering and executing application 140-1) performing or executing within or upon the processor 113 in the communications device 110 at runtime.

It is noted that example configurations disclosed herein include the three dimensional structure rendering and executing application 140-1 itself (i.e., in the form of un-executed or non-performing logic instructions and/or data). The three dimensional structure rendering and executing application 140-1 may be stored on a computer readable medium (such as a floppy disk), hard disk, electronic, magnetic, optical, or other computer readable medium. A three dimensional structure rendering and executing application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a three dimensional structure rendering and executing application 140-1 in the processor 113 as the three dimensional structure rendering and executing process 140-2. Those skilled in the art will understand that the communications device 110 may include other processes and/or software and hardware components, such as an operating system not shown in this example.

A display 150 need not be coupled directly to communications device 110. For example, the three dimensional structure rendering and executing application 140-1 can be executed on a remotely accessible computerized device via the network interface 115. In this instance, the display 150 may be displayed locally to a user 108 of the remote computer, and execution of the processing herein may be client-server based.

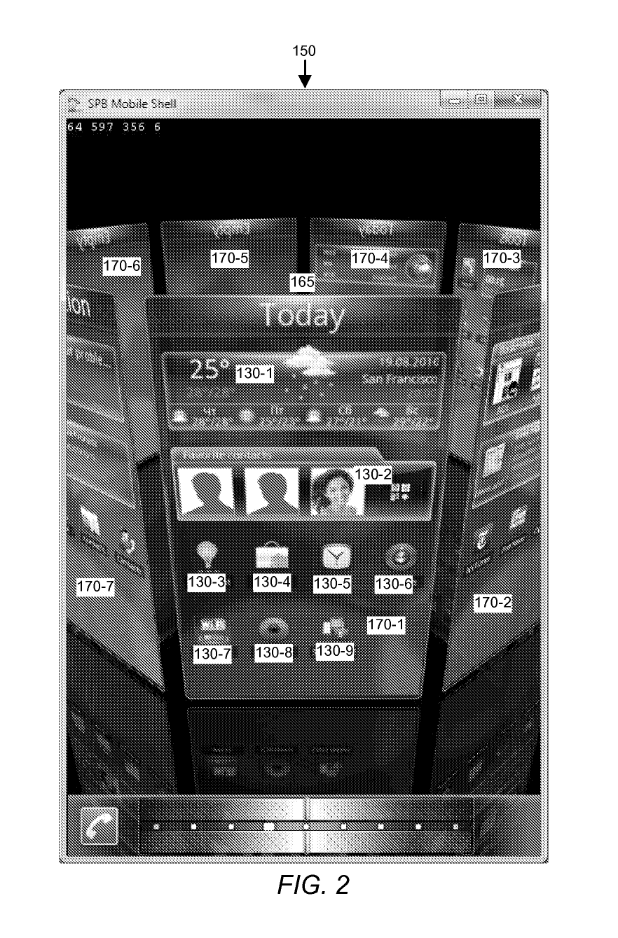

FIG. 2 is an example three dimensional screen shot of a three dimensional structure 165 on the display 150 of a communications device 110 (not shown). The three dimensional structure rendering and executing process 140-2 (not shown) renders a three dimensional structure 165 on the display 150 of the communications device 110. The three dimensional structure 165 is comprised of image representations 130-1 through 130-9 where each image representation 130-N is associated with an available application. For example, image representation 130-1 is associated with an application/widget that renders weather information on the display 150. The image representations 130-N are associated with respective subsets of image representations 170-1 through 170-7, where the subsets of image representations 170-N, or panels, are organized to assist the user 108 with locating and interacting with the image representations 130-N.

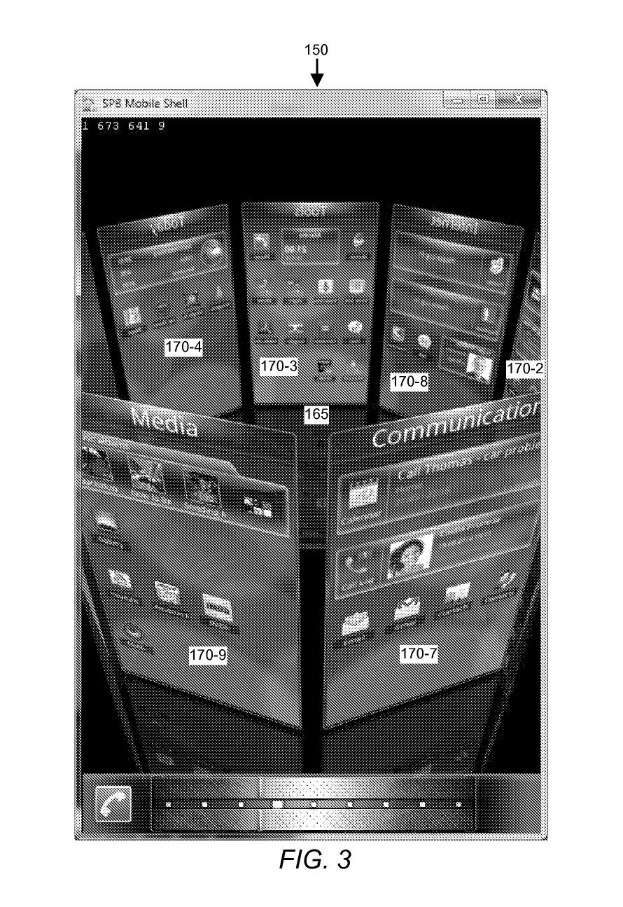

FIG. 3 is an example three dimensional screen shot of a three dimensional structure 165 tilted on the display 150. The three dimensional structure 165 is comprised of a plurality of panels 170-N (i.e., subsets of image representations). In an example embodiment, the panels 170-2, 170-8, 170-3 and 170-4 located in the back of the three dimensional structure 165 are rendered on the display 150 as mirror images whereas the panels 170-9 and 170-7 located in the front of the three dimensional structure 165 are rendered on the display 150 as non-mirror images. In other words, the user looks at the panels 170-9 and 170-7 located in the front of the three dimensional structure 165, and is able to read the wording on those panels left to right.

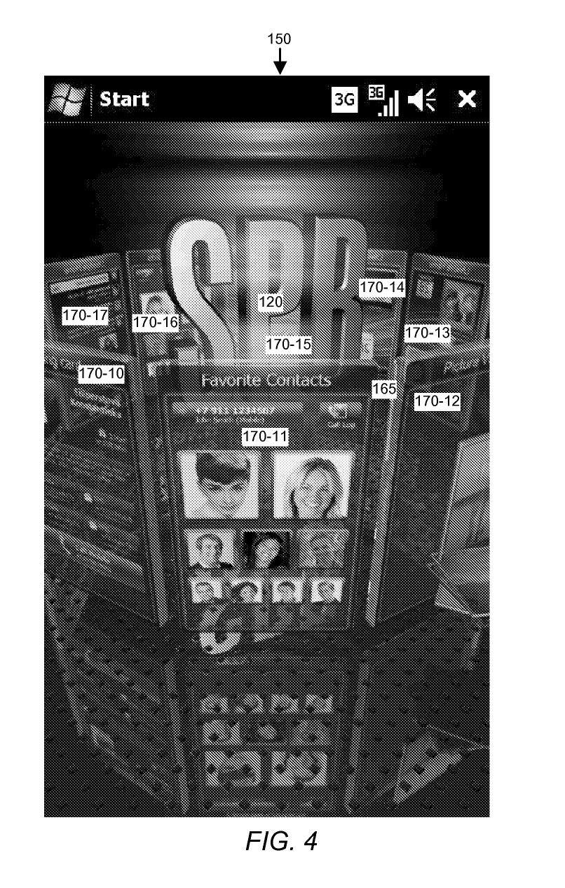

FIG. 4 is an example three dimensional screen shot of a three dimensional structure 165 rendered with a three dimensional graphic 120 positioned along with the three dimensional structure 165 on the display 150. In this example, the three dimensional graphic 120 is rendered in the center of the three dimensional structure 165. The three dimensional graphic 120 is oriented along with the panels 170-N (i.e., subsets of image representations). The three dimensional graphic 120 moves when the user 108 moves the three dimensional structure 165. In other words, when the user 108 rotates the three dimensional structure 165 on the display 150, the three dimensional graphic 120 rotates along with the three dimensional structure 165. The three dimensional graphic 120 maintains its orientation with respect to the three dimensional structure 165. This allows the user 108 to maintain the orientation of the panels within the formation of the three dimensional structure 165.

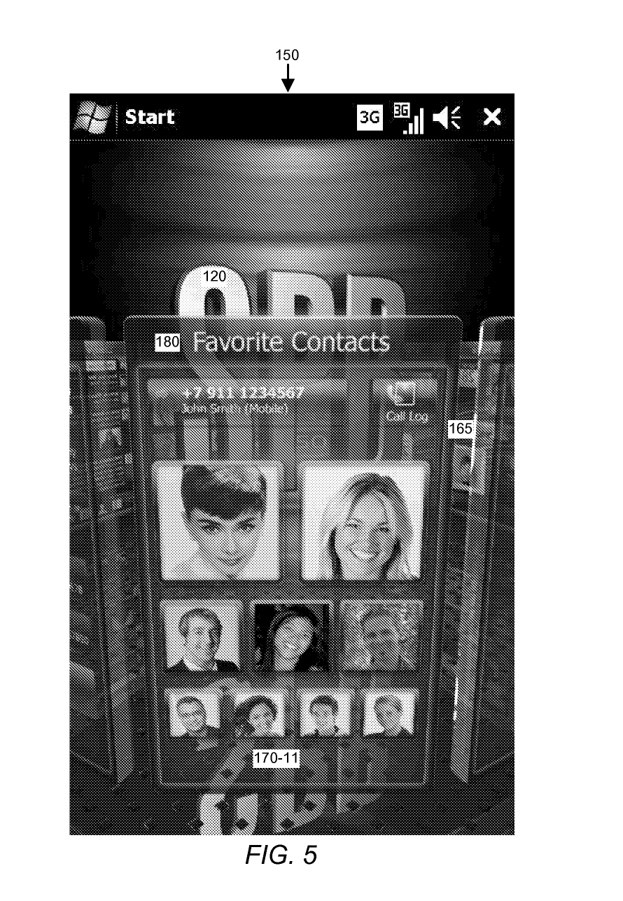

FIG. 5 shows an example distanced view of a three dimensional screen shot of a three dimensional structure 165 with a three dimensional graphic 120 positioned with the three dimensional structure 165 on the display 150. In the distanced view, the user 108 may see only a few of the panels within the three dimensional structure 165. The user 108 may still manipulate the three dimensional structure 165 (i.e., spin or rotate the three dimensional structure 165) within the distanced view. The distanced view allows the user 108 to view additional information contained on a panel 170-11, such as a title bar 180. The user 108 may also select a panel 170-11 to interact with in a close up view (not shown).

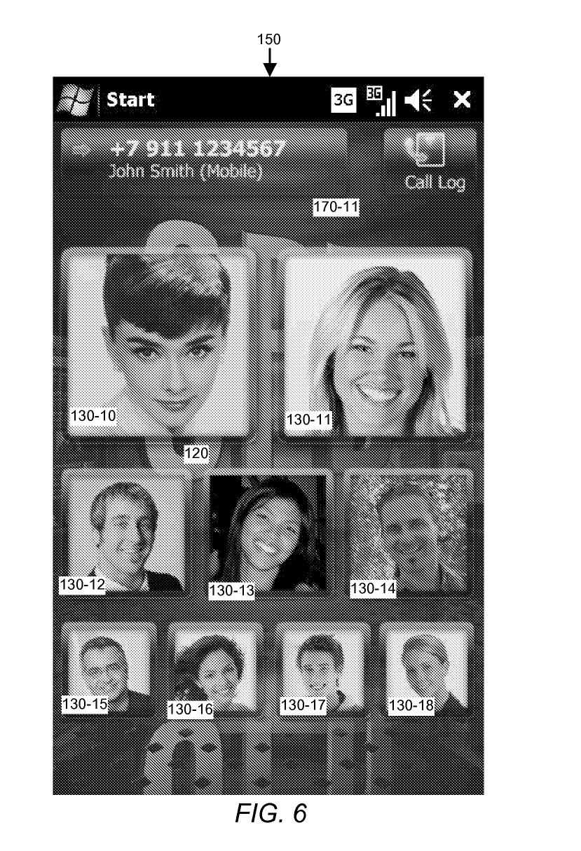

FIG. 6 shows an example close up view of a three dimensional screen shot of a panel 170-11 of the three dimensional structure 165 rendered with a three dimensional graphic 120 on the display 150. In the close up view, the user 108 may interact with the image presentations 130-10, 130-11, 130-12, 130-13, 130-14, 130-15, 130-16, 130-17, and 130-18. In this scenario, the panel 170-11 is rendered with transparency allowing the user 108 to view the three dimensional graphic 120 in the background. In an example embodiment, the three dimensional structure rendering and executing process 140-2 provides the user 108 with a mechanism to perform an action, such as selecting a button, to render the three dimensional structure 165 on the display 150.

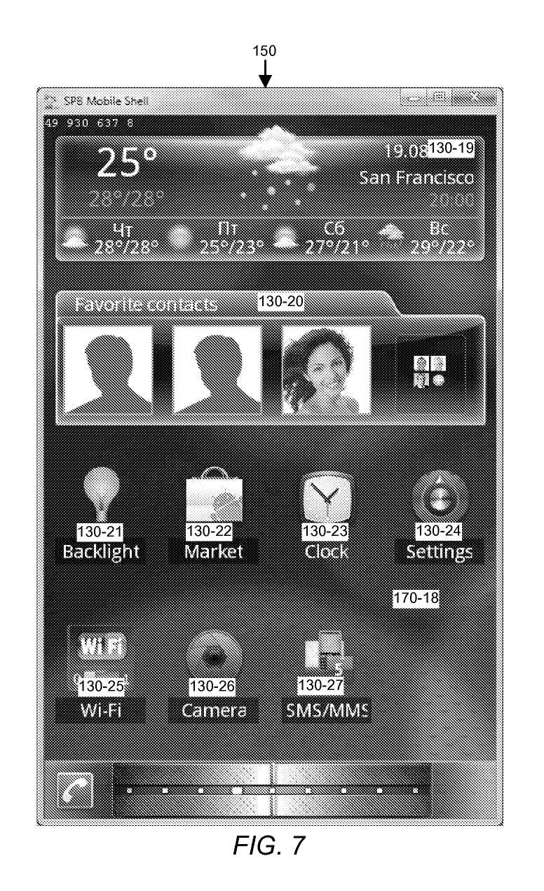

FIG. 7 shows an example close up view of a three dimensional screen shot of a panel 170-18 of the three dimensional structure 165 on the display 150. In the close up view, the user 108 may interact with the image presentations 130-19, 130-20, 130-21, 130-22, 130-23, 130-24, 130-25, 130-26, and 130-27. In this scenario, the panel 170-11 is rendered with an opaque background such that the user 108 cannot see the three dimensional structure 165 in the background of the panel 170-18.

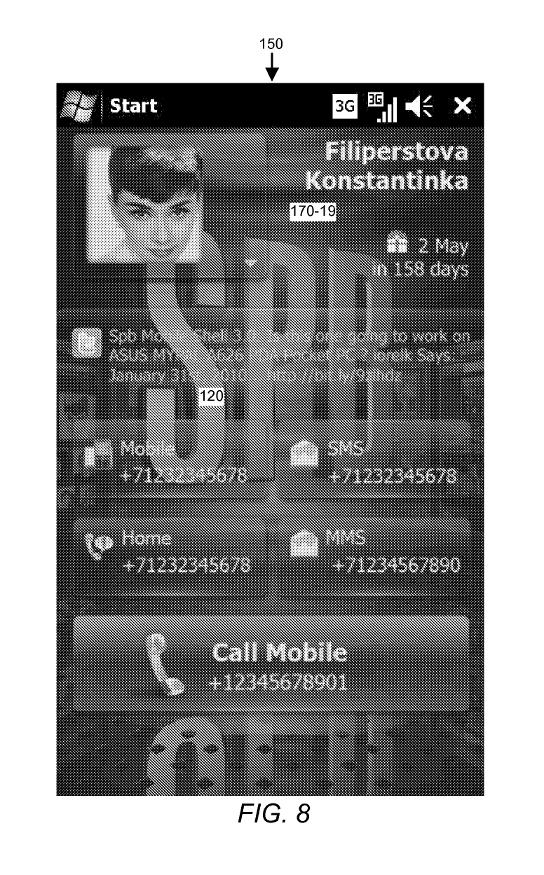

FIG. 8 shows an example close up view of a three dimensional screen shot of a panel 170-19 of the three dimensional structure 165 rendered with a three dimensional graphic 120 oriented to the three dimensional structure 165 on the display 150. In this scenario, the panel 170-19 is rendered with transparency allowing the user 108 to view the three dimensional graphic 120 through the transparency. Viewing the three dimensional graphic 120 allows the user 108 to maintain the orientation of the panel 170-19 within the three dimensional structure 165.

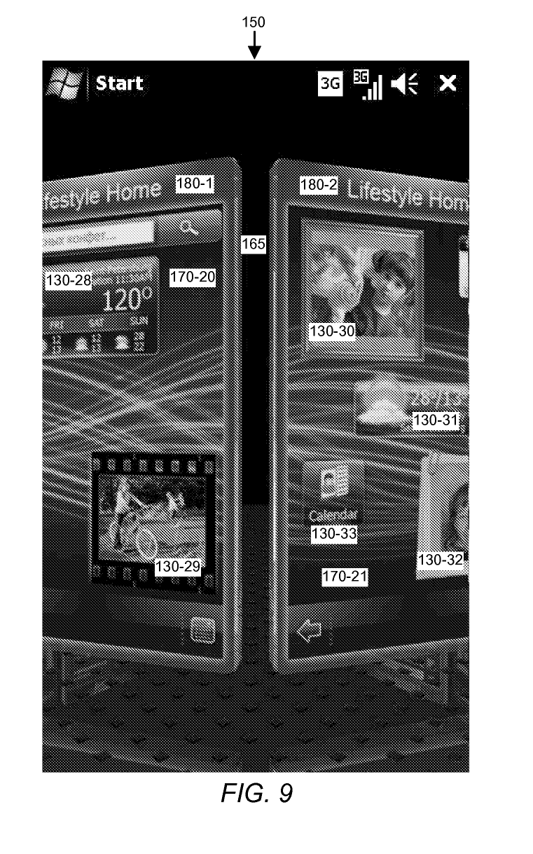

FIG. 9 shows an example distanced view of a three dimensional screen shot of two panels 170-20 and 170-21 of the three dimensional structure 165 on the display 150. The distanced view allows the user 108 to view the panels 170-20 and 170-21 within the formation of the three dimensional structure 165. The distanced view also allows the user 108 to view additional information on each of the panels 170-20 and 170-21, such as title bars 180-1 and 180-2. The title bars 180-1 and 180-2 provide the user 108 with additional information regarding the image representations 130-28, 130-29, 130-30, 130-31, 130-32, and 130-33 associated with each panel 170-20 and 170-21. Within the distanced view, the user 108 may rotate the three dimensional structure 165 to view additional panels. The user 108 may also select a panel to interact with that chosen panel in a close up view (not shown).

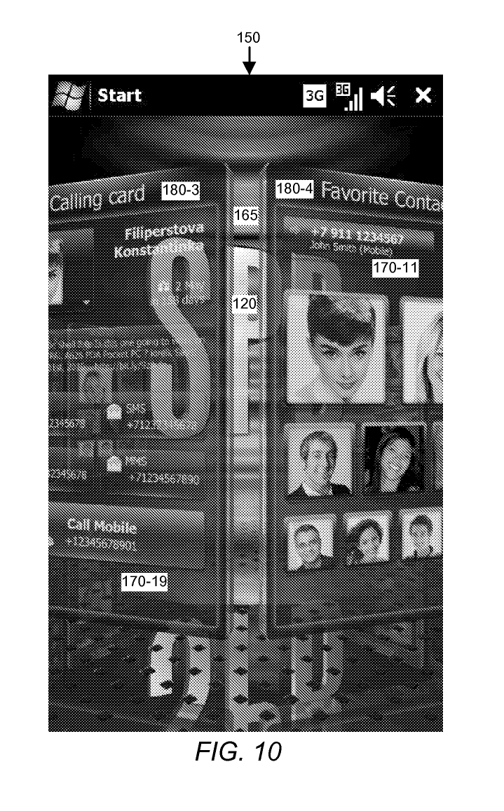

FIG. 10 shows an example distanced view of a three dimensional screen shot of two panels 170-11 and 170-19 of the three dimensional structure 165 rendered with a three dimensional graphic 120 on the display 150. The distanced view allows the user 108 to view the panels 170-11 and 170-19 within the formation of the three dimensional structure 165. The distanced view also allows the user 108 to view additional information on each of the panels 170-11 and 170-19, such as title bars 180-3 and 180-4. The title bars 180-3 and 180-4 provide the user 108 with additional information regarding the image representations 130-N contained within each panel 170-11 and 170-19. In this scenario, the panels 170-11 and 170-19 are rendered with transparency allowing the user 108 to view the three dimensional graphic 120 through the transparency. Viewing the three dimensional graphic 120 allows the user 108 to maintain the orientation of the panels 170-11 and 170-19 within the three dimensional structure 165.

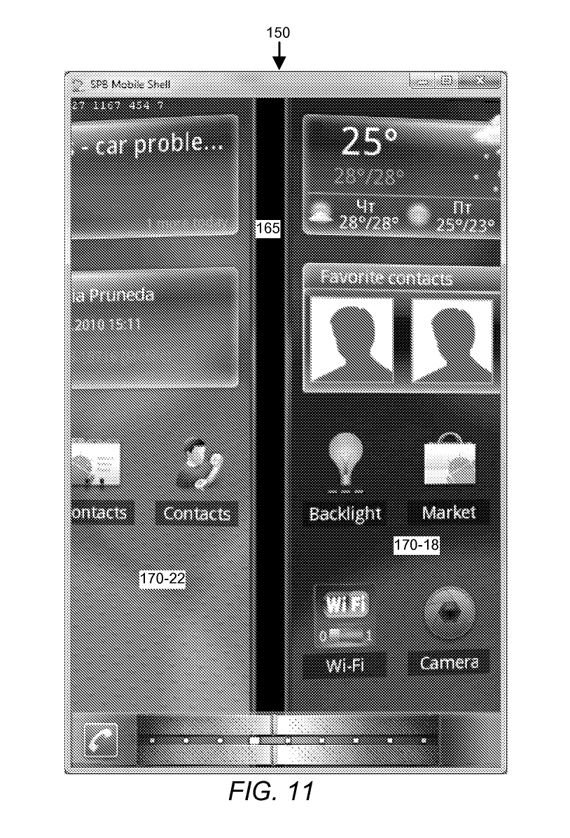

FIG. 11 shows an example close up view of a three dimensional screen shot of two panels 170-18 and 170-22 of the three dimensional structure 165 on the display 150. In this scenario, the user 108 was interacting with one of the panels 170-22 in a close up view, and chose to scroll from the first panel 170-22 to the second panel 170-18. The three dimensional structure rendering and executing process 140-2 maintains the formation of the three dimensional structure 165 in the close up view allowing the user 108 to maintain orientation and organization of the panels within the three dimensional structure 165.

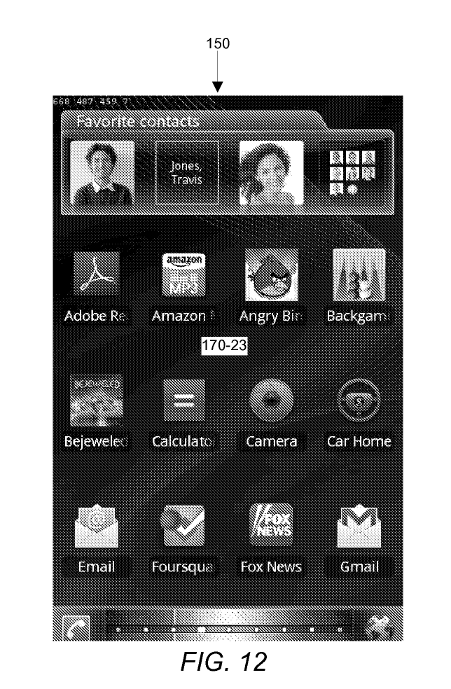

FIG. 12 shows an example close up view of a three dimensional screen shot of a panel 190-23 of the three dimensional structure 165 (not shown) as the user 108 begins to transition from a close up view to a three dimensional structure view (such as is depicted in FIG. 2) on the display 150 of a communications device 110. In an example embodiment, the user 108 may switch from the close up view to a three dimensional structure view by performing a single action, such as tapping the display 150.

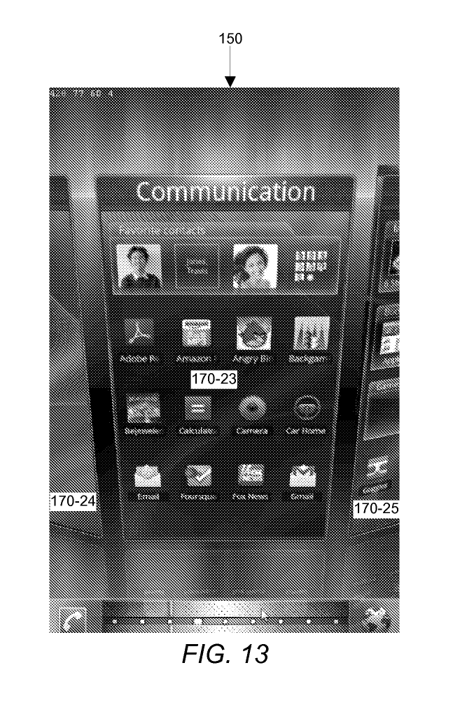

FIG. 13 shows an example screen shot of the three dimensional structure 165 (not shown) during the transition from a close up view to a three dimensional structure view on the display 150 of a communications device 110. When the user 108 performs an action to transition from a close up view (as depicted in FIG. 12) to a three dimensional structure view, the three dimensional structure rendering and executing process 140-2 performs the transition in a gradual and seamless fashion. The user 108 views this transition as it occurs in animation. During the animation sequence, the three dimensional structure 165 appears to move from the close up view to a more distanced view, and, at the same time, the three dimensional structure 165 appears to take shape with additional panels 170-24 and 170-25 coming into view on the display 150.

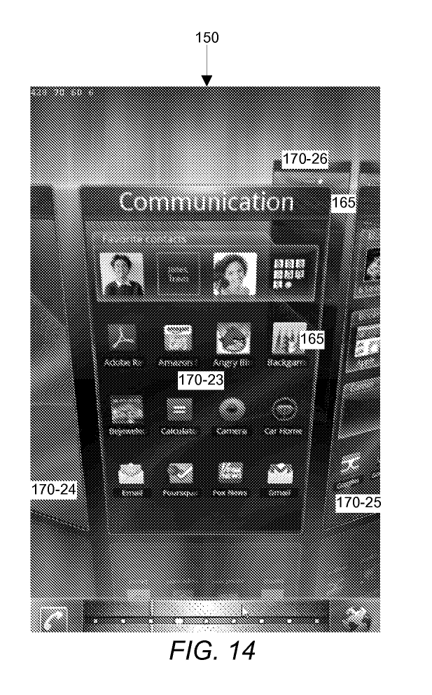

FIG. 14 shows an example screen shot of the three dimensional structure 165 during the transition from a close up view to a three dimensional structure view as the three dimensional structure 165 begins to take shape on the display 150 of a communications device 110. As the transition occurs, each panel also transitions from a flat shape (as depicted in FIG. 12) to a more angled shape as the panels 170-N are arranged in an adjacent, connected (i.e., circular) fashion to form the three dimensional structure 165. The flat shape is more conducive to a user's 108 interaction with a panel 170-23 when the panel 170-23 is viewed in close up view as shown in FIG. 12. The angled shape (i.e., each panel 170-N is angled in the form of an arc to complete the three dimensional structure 165) is more conducive for viewing multiple panels 170-N on the display 150. In FIG. 14, along with panels 170-24 and 17-25 coming into view on the display 150, the user 108 also begins to see the form of the three dimensional structure 165 taking shape as panel 170-26 also comes into view, and takes its place in formation of the three dimensional structure 165. In an example embodiment, the user 108 begins to see a carousel formation take shape as the three dimensional structure rendering and executing process 140-2 gradually and seamlessly transitions from a single panel 170-23 to a carousel formation of panels 170-23 through 170-26. This allows the user 108 to assimilate (in the user's 108 mind) the connection between a single panel 170-23 and that panel's 170-23 placement within the carousel of panels 170-23 through 170-26.

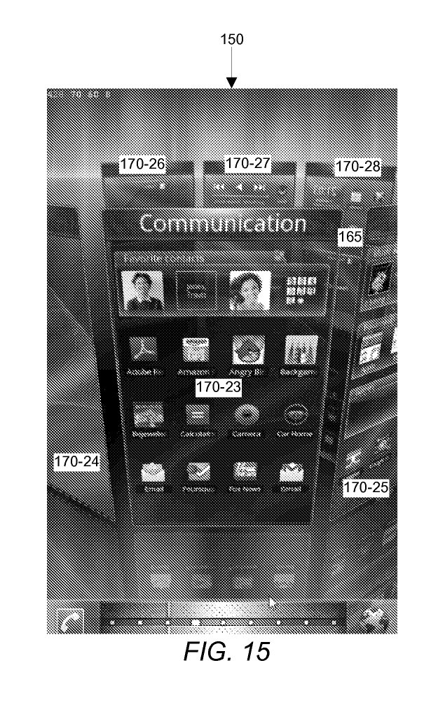

FIG. 15 shows an example screen shot of the three dimensional structure 165 during the transition from a close up view to a three dimensional structure view as the formation of the three dimensional structure 165 nears completion on the display 150 of a communications device 110. During the animated sequence of the transition from the close up view (as depicted in FIG. 12) to the three dimensional structure 165 view, the three dimensional structure rendering and executing process 140-2 appears to ‘zoom out’ from the close up view to a more distanced view, and the formation of the three dimensional structure 165 gradually and seamlessly takes shape in animation. The user 108 sees the transition from one panel 170-23 to a plurality of panels 170-24, 170-25, 170-26, 170-27 and 170-28 forming the three dimensional structure 165. In an example embodiment, the panels 170-23 through 170-28 form a carousel formation.

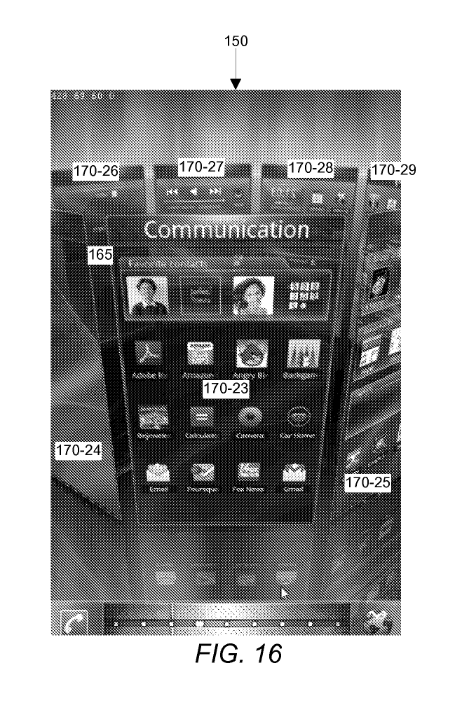

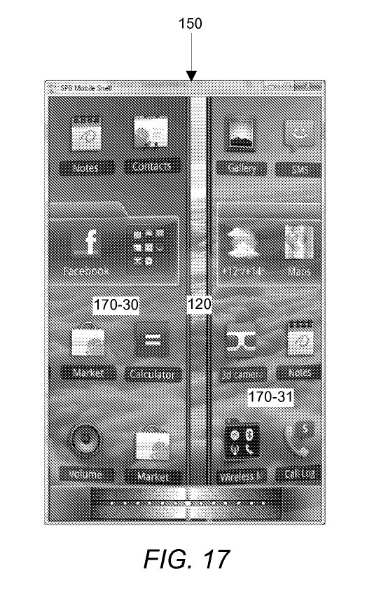

FIG. 16 shows an example screen shot of the completed three dimensional structure 165 on the display 150 of a communications device 110. At the completion of the animated sequence, the three dimensional structure rendering and executing process 140-2 completes the formation of the three dimensional structure 165 containing panels 170-23, 170-24, 170-25, 170-26, 170-27, 170-28, and 170-29. The camera angle of the display transitions from a close up view (as depicted in FIG. 12) to a gradual zooming out (as depicted sequentially in FIGS. 13, 14, 15 and 16) until the final camera angle is one of a more distanced view allowing the user 108 to view the completed three dimensional structure 165. This transition occurs in a gradual seamless fashion. The seamless transition ensures that user 108 understands how these two formations (i.e., the close up view, and the three dimensional structure 165 view) are connected. In an example embodiment, when a user 108 desires to transition from the three dimensional structure 165 view to a close up view, the three dimensional structure rendering and executing process 140-2 performs the steps explained in FIGS. 12, 13, 14, 15 and 16 in reverse. FIG. 17 shows an example screen shot of two panels 170-30 and 170-31 each with a degree of transparency rendered along with a three dimensional graphic 120 on the display 150 of a communications device 110. In an example embodiment, the three dimensional graphic 120 may be positioned as a background, for example, when the user 108 transitions between panels 170-30 and 170-31. The panels 170-30 and 170-31 may be rendered with an opaque background, or with a degree of transparency. When the panels 170-30 and 170-31 are rendered with a degree of transparency, the three dimensional graphic 120 may be visible through the panels 170-30 and 170-31 as is shown in FIG. 17. When the panels 170-30 and 170-31 are rendered with an opaque background (not shown), the three dimensional graphic 120 is not visible through the panels 170-30, but may still be visible, for example, when the user 108 transitions from one panel 170-30 to the next adjacent panel 170-31 as is shown in FIG. 17. During this transition, the three dimensional graphic 120 is viewed in the adjoining space that separates the two panels 170-30 and 170-31.

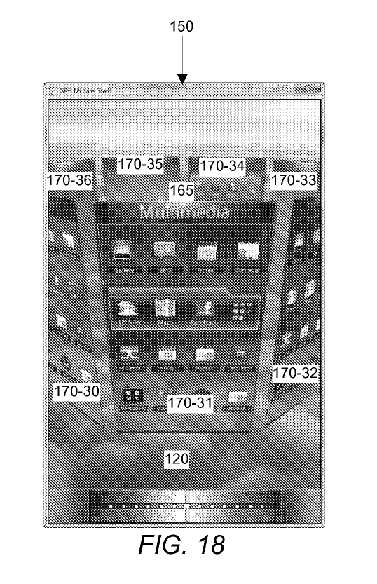

FIG. 18 shows an example screen shot of a three dimensional structure 165 rendered along with a three dimensional graphic 120 on the display 150 of a communications device 110. In an example embodiment, and as shown in FIG. 4, the three dimensional graphic 120 may be positioned inside the three dimensional structure 165. In another example embodiment as shown in FIG. 18, the three dimensional graphic 120 may be positioned outside the three dimensional structure 165. In this embodiment, the three dimensional structure 165 appears to be rendered against a background (i.e., the three dimensional graphic 120). The panels 170-30, 170-31, 170-32, 170-33, 170-34, 170-35 and 170-36 of the three dimensional structure 165 may be rendered with an opaque background, or with a degree of transparency. In an example embodiment, when the panels 170-30 through 170-36 are rendered with a degree of transparency, the three dimensional graphic 120 may be visible through the panels 170-30 through 170-36. In another example embodiment, when the panels 170-30 through 170-36 are rendered with an opaque background, the three dimensional graphic 120 is not visible through the panels 170-30 through 170-36, but may still be visible as a background as is shown in FIG. 18.

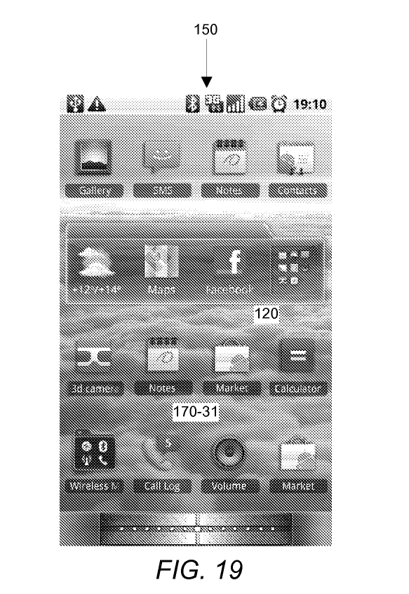

FIG. 19 shows example screen shot of a close up view of a panel 170-31 rendered with a degree of transparency. The panel 170-31 is rendered along with a three dimensional graphic 120 (rendered as a background) on the display 150 of a communications device 110. The panel 170-30 may be rendered with an opaque background, or with a degree of transparency. When the panel 170-30 is rendered with a degree of transparency, the three dimensional graphic 120 may be visible through the panel 170-30. In an example embodiment, the degree of transparency associated with a panel 170-30 may change depending on the view of that panel 170-30. For example, a panel 170-30 may have a degree of transparency when in a three dimensional structure 165 view (as shown in FIG. 18) and/or distanced view (as shown in FIG. 17), but may be rendered with an opaque background when rendered on the display 150 in a close up view (as shown in FIG. 19). The transitions between the views are seamless. In an example embodiment, the transparency of the panel background gradually changes (i.e., from opaque to transparent) during the animation switching the view, for example from the three dimensional structure 165 view to the close up view. It should be noted that it is the background that has a degree of transparency but applications, such as widget might not be transparent.

Further details of configurations explained herein will now be provided with respect to a flow chart of processing steps that show the high level operations disclosed herein to perform the three dimensional structure rendering and executing process 140-2.

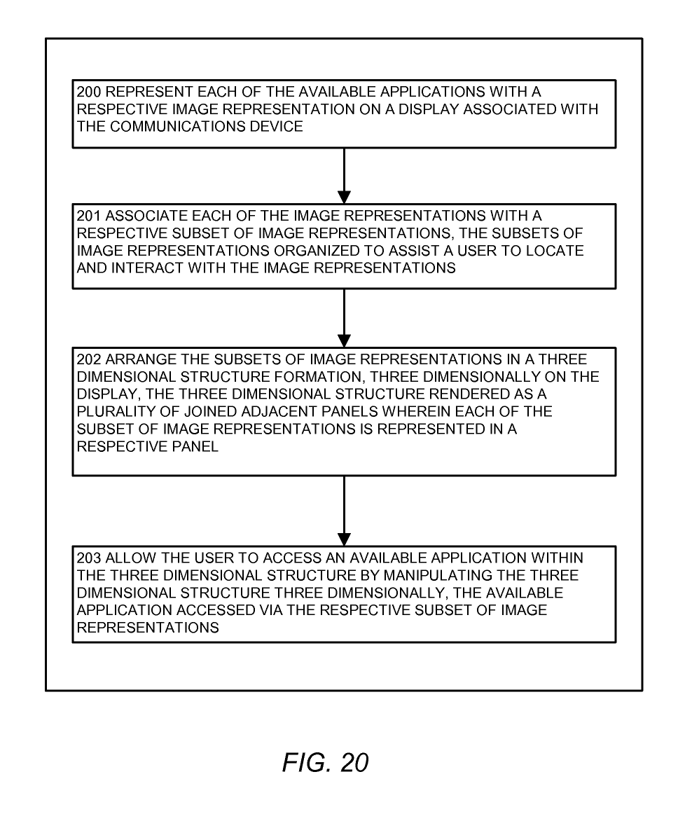

FIG. 20 is an embodiment of the steps performed by three dimensional structure rendering and executing process 140-2 when it represents each of the available applications with a respective image representation 130-N on a display 150 associated with the communications device 110.

In step 200, the three dimensional structure rendering and executing process 140-2 represents each of the available applications including widgets with a respective image representation 130-N on a display 150 associated with the communications device 110. In an example embodiment, the image representation 130-N may be an icon that the user 108 selects to access the associated application. The image representation 130-N may also be a shortcut, widget, or folder containing a plurality of image representations 130-N.

In step 201, the three dimensional structure rendering and executing process 140-2 associates each of the image representations 130-N with a respective subset of image representations 170-N. The subsets of image representations 170-N are organized to assist a user 108 in locating and interacting with the image representations 130-N. FIG. 2 shows an example subset of image representations 170-1 containing frequently accessed applications, such as a weather widget 130-1, a folder of favorite contacts 130-2, and frequently used applications represented by image representations 130-3, 130-4, 130-5, 130-6, 130-7, 130-8, and 130-9.

In step 202, the three dimensional structure rendering and executing process 140-2 arranges the subsets of image representations 170-N in a three dimensional structure 165, three dimensionally, on the display 150. The three dimensional structure 165 is rendered as a plurality of joined adjacent panels 170-N where each of the subset of image representations 170-N is represented in a respective panel 170-N. FIG. 3 shows an example three dimensional structure 165 comprised of panels (i.e., subsets of image representations) 170-7, 170-2, 170-8, 170-3, 170-4, and 170-9. The three dimensional structure 165 is tilted allowing the user 108 to view panels 170-N in the front of the three dimensional structure 165 as well as panels 170-N in the back of the three dimensional structure 165. In an example embodiment, a first subset of image representations 170-9 visible in front of the three dimensional structure 165 is visible concurrently with a second subset of image representations 170-3 visible in back of the three dimensional structure 165, where the three dimensional structure 165 is comprised of both the first subset of image representations 170-9, and the second subset of image representations 170-3 as shown in FIG. 3.

In step 203, the three dimensional structure rendering and executing process 140-2 allows the user 108 to access an available application within the three dimensional structure 165 by manipulating the three dimensional structure 165 three dimensionally. The available application is accessed via the respective subset of image representations 170-N. In other words, the user 108 drags a finger across the display 150 to rotate or spin the three dimensional structure 165 on the display 150. The user 108 may select an available application by selecting the panel 170-N from the three dimensional structure 165 (for example, tapping the display 150 at the location of that panel) that contains the image representation 130-N associated with that application. For example, in FIG. 3, the user 108 may select any of the visible panels 170-9, 170-7, 170-2, 170-8, 170-3 and 170-4 to access applications represented by respective image representations 130-N.

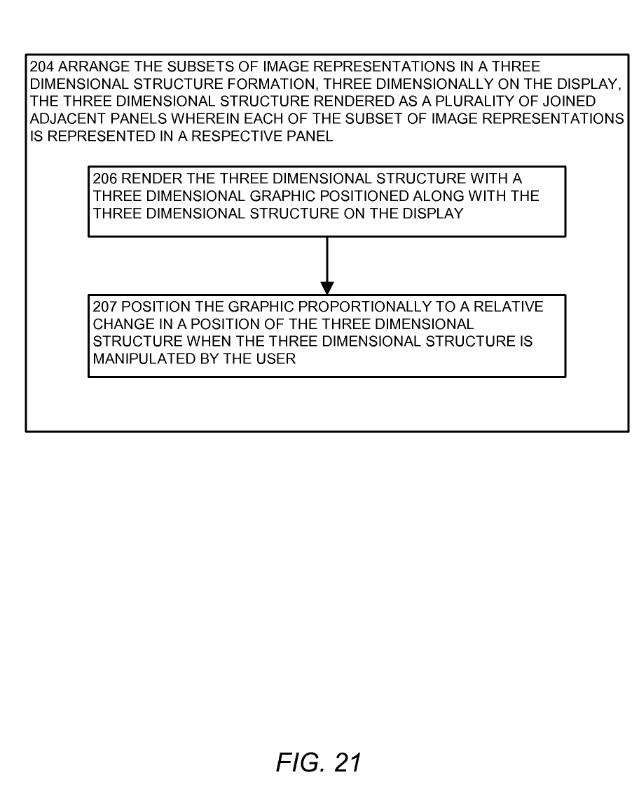

FIG. 21 is an embodiment of the steps performed by three dimensional structure rendering and executing process 140-2 when it arranges the subsets of image representations 170-N in a three dimensional structure 165, three dimensionally, on the display 150.

In step 204, the three dimensional structure rendering and executing process 140-2 arranges the subsets of image representations 170-N in a three dimensional structure 165, three dimensionally on the display 150. The three dimensional structure 165 is rendered as a plurality of joined adjacent panels 170-N where each of the subset of image representations 170-N is represented in a respective panel 170-N. FIG. 3 shows an example three dimensional structure 165 comprised of panels (i.e., subsets of image representations) 170-7, 170-2, 170-8, 170-3, 170-4, and 170-9. The three dimensional structure 165 is tilted allowing the user 108 to view panels 170-9 and 170-7 in the front of the three dimensional structure 165 as well as panels 170-2, 170-8, 170-3, and 170-4 in the back of the three dimensional structure 165.

In step 206, the three dimensional structure rendering and executing process 140-2 renders the three dimensional structure 165 with a three dimensional graphic 120 positioned along with the three dimensional structure 165 on the display 150 as shown in FIG. 4. In an example embodiment, the three dimensional graphic 120 is positioned in the center of the three dimensional structure 165 to orient the user 108 to the positions of the panels 170-N within the three dimensional structure 165. In other words, if the user 108 is viewing the front of the three dimensional structure 165, the user 108 sees the front of the three dimensional graphic 120. Thus, a user 108 viewing the position of the three dimensional graphic 120 will quickly be oriented to the position of the three dimensional structure 165 on the display 150, and specifically, how the panels 170-N are positioned in the three dimensional structure 165.

In step 207, the three dimensional structure rendering and executing process 140-2 positions the three dimensional graphic 120 proportionally to a relative change in the position of the three dimensional structure 165 when the three dimensional structure 165 is manipulated by the user 108. In an example embodiment, as a user 108 manipulates the three dimensional structure 165, the three dimensional structure rendering and executing process 140-2 also repositions the three dimensional graphic 120 in relation to the change in position of the three dimensional structure 165. When a user 108 rotates the three dimensional structure 165 on the display 150, the three dimensional structure rendering and executing process 140-2 also rotates the three dimensional graphic 120 to maintain the orientation of the three dimensional graphic 120 with respect to the three dimensional structure 165.

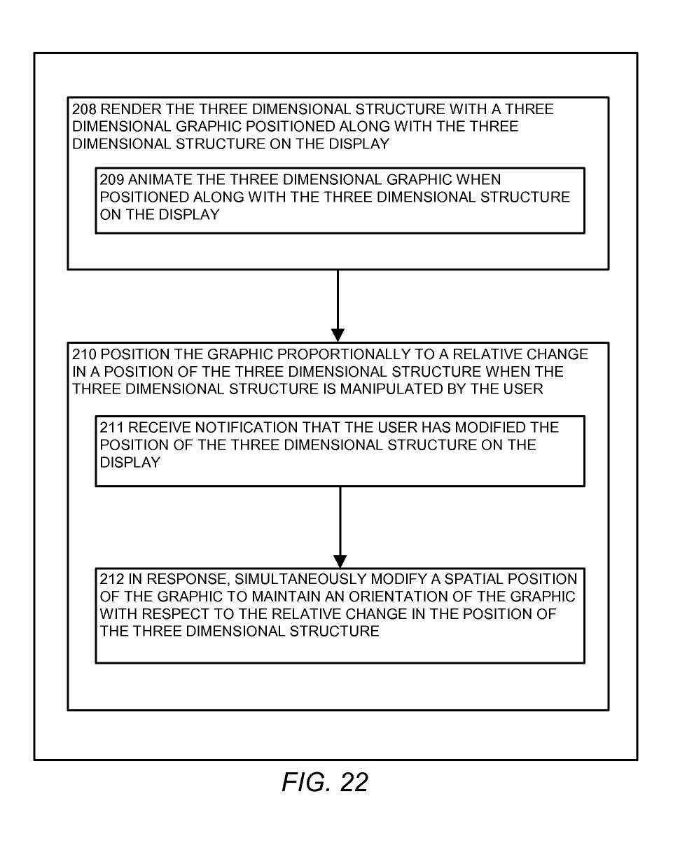

FIG. 22 is an embodiment of the steps performed by three dimensional structure rendering and executing process 140-2 when it renders the three dimensional structure 165 with a three dimensional graphic 120 positioned along with the three dimensional structure 165 on the display 150.

In step 208, the three dimensional structure rendering and executing process 140-2 renders the three dimensional structure 165 with a three dimensional graphic 120 positioned along with the three dimensional structure 165 on the display 150. In an example embodiment, the purpose of the three dimensional graphic 120 is to orient the user 108 to the position of a particular panel with respect to the plurality of panels 170-N that comprise the three dimensional structure 165. The three dimensional graphic 120 moves when the user 108 moves the three dimensional structure 165. In other words, when the user 108 rotates the three dimensional structure 165 on the display 150, the three dimensional graphic 120 rotates along with the three dimensional structure 165, and the three dimensional graphic 120 maintains its orientation with respect to the three dimensional structure 165. This allows the user 108 to maintain the orientation of the panels within the formation of the three dimensional structure 165.

In step 209, the three dimensional structure rendering and executing process 140-2 animates the three dimensional graphic 120 when it is positioned along with the three dimensional structure 165 on the display 150. For example, the three dimensional graphic 120 may be an animated graphic including snow/rain where the animation depicts particles falling.

In step 210, the three dimensional structure rendering and executing process 140-2 positions the three dimensional graphic 120 proportionally to a relative change in a position of the three dimensional structure 165 when the user 108 manipulates the three dimensional structure 165. The three dimensional graphic 120 is positioned to maintain an orientation with respect to the position of the three dimensional structure 165.

In step 211, the three dimensional structure rendering and executing process 140-2 receives notification that the user 108 has modified the position of the three dimensional structure 165 on the display 150. In an example embodiment, the user 108 modifies the position of the three dimensional structure 165 by, for example, rotating or spinning the three dimensional structure 165. The user 108 may perform this action by dragging a finger across the display 150. In response, the three dimensional structure rendering and executing process 140-2 rotates the three dimensional structure 165 on the display in an animated spin, allowing the user 108 to view the plurality of panels 170-N as the three dimensional structure 165 spins on the display 150.

In step 212, the three dimensional structure rendering and executing process 140-2, in response, simultaneously modifies a spatial position of the three dimensional graphic 120 to maintain an orientation of the three dimensional graphic 120 with respect to the relative change in the position of the three dimensional structure 165. In an example embodiment, as the user 108 rotates the three dimensional structure 165 on the display 150, the three dimensional structure rendering and executing process 140-2 also simultaneously rotates the three dimensional graphic 120, maintaining the orientation of the three dimensional graphic 120 with respect to the rotation of the three dimensional structure 165 on the display 150. When the user 108 views the front of the three dimensional structure 165, the user 108 is also viewing the front of the three dimensional graphic 120. As the user 108 rotates the three dimensional structure 165 on the display 150, the three dimensional structure rendering and executing process 140-2 simultaneously rotates the three dimensional graphic 120 on the display 150. In other words, if the three dimensional structure 165 is rotated from the front of the three dimensional structure 165 to the back of the three dimensional structure 165, the three dimensional structure rendering and executing process 140-2 simultaneously also rotates the three dimensional graphic 120 front to back.

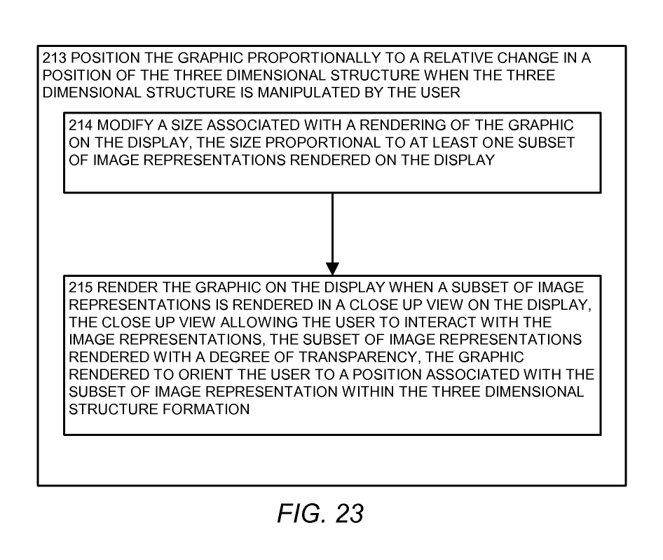

FIG. 23 is an embodiment of the steps performed by three dimensional structure rendering and executing process 140-2 when it positions the three dimensional graphic 120 proportionally to a relative change in a position of the three dimensional structure 165 when the three dimensional structure 165 is manipulated by the user 108.

In step 213, the three dimensional structure rendering and executing process 140-2 positions the three dimensional graphic 120 proportionally to a relative change in a position of the three dimensional structure 165 when the three dimensional structure 165 is manipulated by the user 108. The three dimensional graphic 120 maintains an orientation with respect to the three dimensional structure 165 on the display 150.

In step 214, the three dimensional structure rendering and executing process 140-2 modifies a size associated with a rendering of the three dimensional graphic 120 on the display 150. The size is proportional to at least one panel (i.e., subset of image representations) 170-11 rendered on the display 150. In an example embodiment, the user 108 may view the three dimensional structure 165 in the three dimensional structure 165 view as shown in FIGS. 1 and 2. The user 108 may also view the three dimensional structure 165 within a distanced view as shown in FIG. 5. The distanced view allows the user 108 a closer view of individual panels while still maintaining the formation of the three dimensional structure 165 on the display 150. In an example embodiment, when the user 108 chooses to view the three dimensional structure 165 within the distanced view, the three dimensional structure rendering and executing process 140-2 modifies the size of the three dimensional graphic 120 to maintain proportion to the three dimensional structure 165 rendered on the display 150. FIG. 5 depicts an example distanced view of a panel 170-11 where the three dimensional structure rendering and executing process 140-2 has resized the three dimensional graphic 120 such that the user 108 is able to view the three dimensional graphic 120. This allows the user 108 to maintain an orientation of the panel's 170-11 position within the three dimensional structure 165. In another example embodiment, the three dimensional graphic 120 may be rendered larger than the panel 170-11 so that the three dimensional graphic 120 is still visible even if the panel 170-11 is rendered with an opaque background (i.e., without a degree of transparency).

In step 215, the three dimensional structure rendering and executing process 140-2 renders the three dimensional graphic 120 on the display 150 when a panel (i.e., subset of image representations) 170-N is rendered in a close up view on the display 150 as depicted in FIG. 6. The close up view allows the user 108 to interact with the image representations 130-10, 130-11, 130-12, 130-13, 130-14, 130-15, 130-16, 130-17, and 130-18. In an example embodiment, the panel (i.e., subset of image representations) 170-11 is rendered with a degree of transparency such that the three dimensional graphic 120 is visible behind the panel 170-11. The three dimensional graphic 120 is rendered to orient the user 108 to a position associated with the panel 170-11 within the three dimensional structure 165.

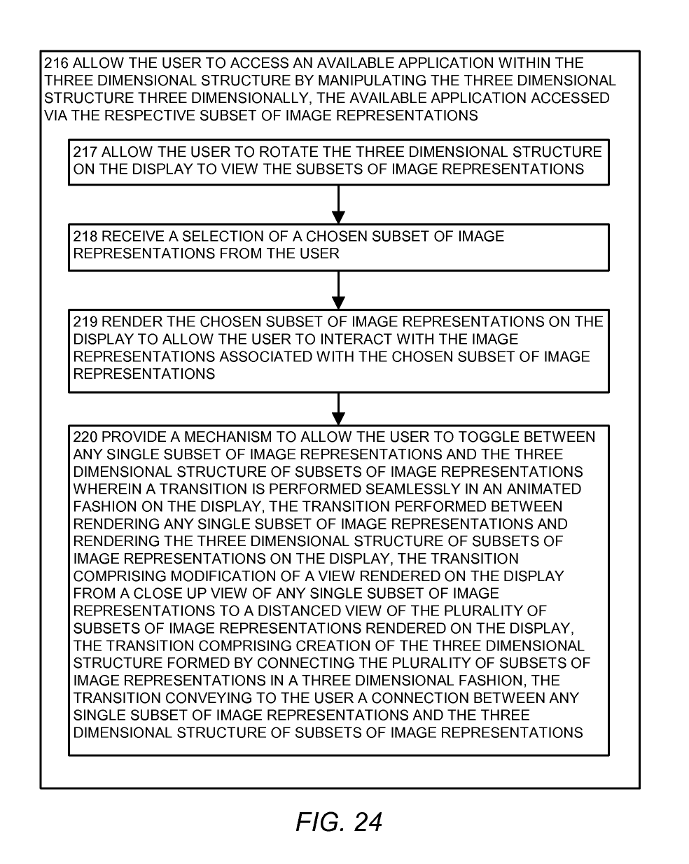

FIG. 24 is an embodiment of the steps performed by three dimensional structure rendering and executing process 140-2 when it allows the user 108 to access an available application within the three dimensional structure 165 by manipulating the three dimensional structure 165 three dimensionally.

In step 216, the three dimensional structure rendering and executing process 140-2 allows the user 108 to access an available application within the three dimensional structure 165 by manipulating the three dimensional structure 165 three dimensionally. The available application is accessed via the respective panel (i.e., subset of image representations) 170-N. When the user 108 wishes to access a particular application, the user 108 taps on the panel 170-N containing the image representation 130-N associated with that application. In an example embodiment, when the user 108 taps on the panel 170-N, the three dimensional structure rendering and executing process 140-2 renders the panel 170-N within a close up view, and the user 108 is able to interact with that panel 170-N. The user 108 accesses the application by interacting with the image representation 130-N associated with that application.

In step 217, the three dimensional structure rendering and executing process 140-2 allows the user 108 to rotate the three dimensional structure 165 on the display 150 to view the subsets of image representations 170-N. In an example embodiment, the user 108 drags a finger across the display 150 to rotate or ‘spin’ the three dimensional structure 165 on the display 150. The user 108 may ‘spin’ the three dimensional structure 165 to view the panels 170-N (i.e., subsets of image representations) on the display 150. As the three dimensional structure 165 spins, the panels are rendered on the display 150.

In step 218, the three dimensional structure rendering and executing process 140-2 receives a selection of a chosen panel (i.e., subset of image representations) 170-N from the user 108. In an example embodiment, the user 108 may select the panel 170-N by tapping on the display 150 at the location of the panel 170-N to access that panel 170-N.

In step 219, the three dimensional structure rendering and executing process 140-2 renders the chosen panel (i.e., subset of image representations) 170-N on the display 150 to allow the user 108 to interact with the image representations 130-N associated with the chosen subset of image representations 170-N. FIGS. 6 and 7 show examples of close up views of panels that allow the user 108 to interact with the image representations 130-N contained within those panels 170-N.

In step 220, the three dimensional structure rendering and executing process 140-2 provides a mechanism to allow the user 108 to toggle between any single subset of image representations 170-23, and the three dimensional structure 165 of subsets of image representations 170-N. The transition is performed gradually and seamlessly in an animated fashion on the display 150 as depicted in FIGS. 12, 13, 14, 15 and 16. The transition is performed between rendering any single subset of image representations 170-23, and rendering the three dimensional structure 165 of subsets of image representations 170-N on the display 150. The transition modifies a close up view of any single subset of image representations 170-23 (as depicted in FIG. 12) to a distanced view of the plurality of subsets of image representations 170-N (as depicted in FIG. 16) rendered on the display 150. The transition creates the three dimensional structure 165 by connecting the plurality of subsets of image representations 170-N in a three dimensional fashion. The user 108 sees the transition from the single panel 170-23 (i.e., the single subset of image representations 170-23) to the completed three dimensional structure 165 formed by the subsets of image representations 170-23 through 170-29. This transition conveys to the user 108 the connection between any single subset of image representations 170-23, and the three dimensional structure 165 of subsets of image representations 170-23 through 170-29.

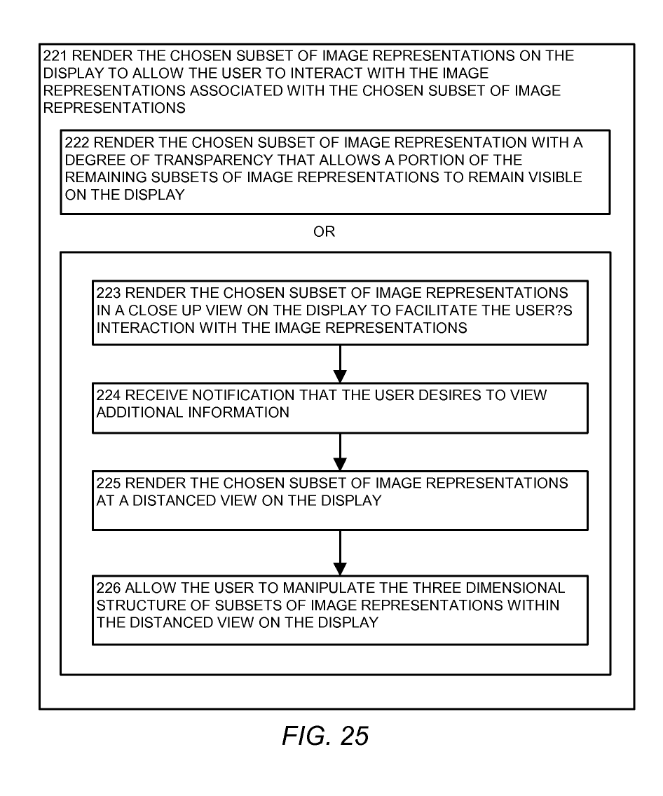

FIG. 25 is an embodiment of the steps performed by three dimensional structure rendering and executing process 140-2 when it renders the chosen panel 170-N (i.e., subset of image representations) on the display 150 to allow the user 108 to interact with the image representations 130-N associated with the chosen panel 170-N.

In step 221, the three dimensional structure rendering and executing process 140-2 renders the chosen panel (i.e., subset of image representations 170-N) on the display 150 to allow the user 108 to interact with the image representations 130-N associated with the chosen panel 170-N. In an example embodiment, the panel is rendered on the display 150 in a close up view, as shown in FIGS. 6 and 7.

Alternatively, in step 222, the three dimensional structure rendering and executing process 140-2 renders the chosen subset of image representations 170-N with a degree of transparency that allows a portion of the remaining panels (i.e., subsets of image representations) 170-N to remain visible on the display 150. In an example embodiment, the panel 170-19 is rendered with a degree of transparency as shown in FIG. 8. This allows the user 108 to view some of the remaining panels 170-N of the three dimensional structure 165 through the transparency of the panel 170-19 rendered in a close up view on the display 150.

In step 223, the three dimensional structure rendering and executing process 140-2 renders the chosen panel (i.e., subset of image representations) 170-N in a close up view on the display 150 to facilitate the user's 108 interaction with the image representations 130-N. FIG. 7 is an example screen shot of a close up view of a panel 170-18 where the user 108 may interact with any of the image representations 130-N rendered on the display 150. In an example embodiment, the user 108 may switch from a close up view of a panel 170-N to a three dimensional structure 165 view of the three dimensional structure 165 on the display.

In step 224, the three dimensional structure rendering and executing process 140-2 receives notification that the user 108 desires to view additional information. In an example embodiment, the user 108 is interacting with the panel 170-N in a close up view. The close up view, as depicted in FIG. 6, allows the user 108 to interact with the image representations 130-N contained on the panel 170-N, but does not render all the information on the panel 170-N that is available to the user 108. Thus, while the user 108 is interacting with the panel 170-N within a close up view, the user 108 may indicate that he/she wishes to view additional information associated with the panel 170-N.

In step 225, the three dimensional structure rendering and executing process 140-2 renders the chosen panel (i.e., subset of image representations) 170-N at a distanced view on the display 150. In an example embodiment, when the user 108 indicates that he/she wishes to view additional information associated with the panel 170-N, the three dimensional structure rendering and executing process 140-2, in response, renders the chosen panel 170-N at a distanced view, as shown in FIG. 5. The distanced view still allows the user 108 a better view of the contents of the panel 170-N while still maintaining the three dimensional structure 165 on the display 150. Maintaining the three dimensional structure 165 on the display 150 allows the user 108 to maintain an orientation of the position of a particular panel 170-N within the three dimensional structure 165.

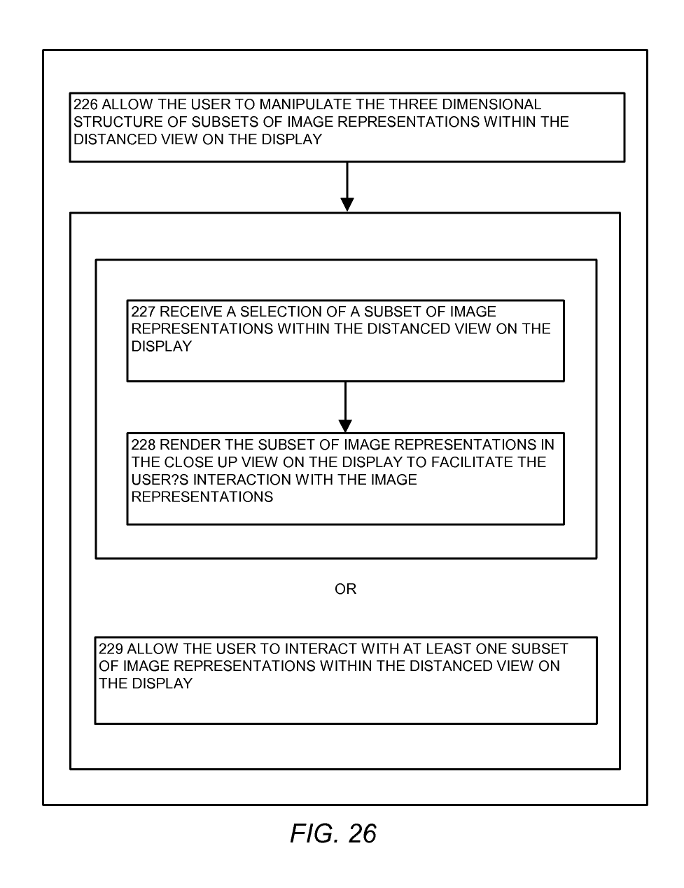

FIG. 26 is an embodiment of the steps performed by three dimensional structure rendering and executing process 140-2 when it allows the user 108 to manipulate the three dimensional structure 165 of panels (i.e., subsets of image representations) 170-N within the distanced view on the display 150.

In step 226, the three dimensional structure rendering and executing process 140-2 allows the user 108 to manipulate the three dimensional structure 165 of panels (i.e., subsets of image representations) 170-N within the distanced view on the display 150. In an example embodiment, the user 108 may spin the three dimensional structure 165 on the display 150 when the three dimensional structure 165 is rendered within the distanced view. The user 108 may rotate the three dimensional structure 165 on the display 150 to view and/or select other panels within the three dimensional structure 165.

In step 227, the three dimensional structure rendering and executing process 140-2 receives a selection of a panel (i.e., subset of image representations) 170-N within the distanced view on the display 150. When viewing the three dimensional structure 165 within the distanced view, the user 108 may select a panel 170-N within the display 150, for example, by tapping the screen of the display 150 at the location of that panel 170-N.

In step 228, the three dimensional structure rendering and executing process 140-2 renders the panel (i.e., subset of image representations) 170-N in the close up view on the display 150 to facilitate the user's 108 interaction with the image representations 130-N. In an example embodiment, in response to a user's 108 selection of a panel 170-N within the distanced view, the three dimensional structure rendering and executing process 140-2 renders the chosen panel 170-N in a close up view, allowing the user 108 to interact with the image representations 130-N contained within that panel 170-N.

Alternatively, in step 229, the three dimensional structure rendering and executing process 140-2 allows the user 108 to interact with at least one panel (i.e., subset of image representations) 170-N within the distanced view on the display 150.

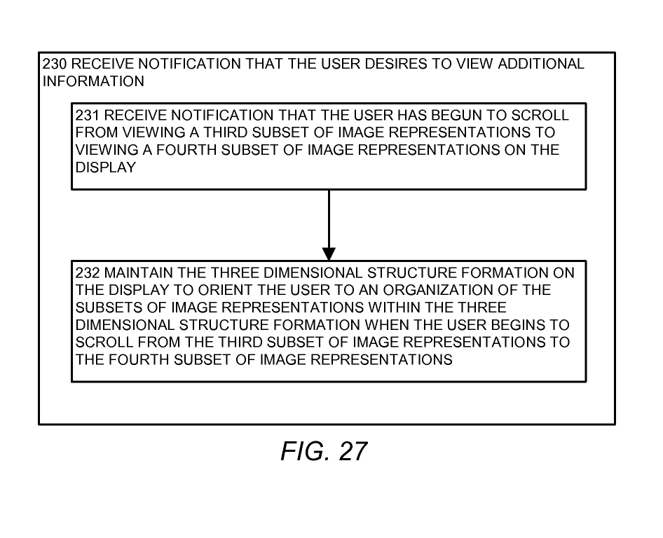

FIG. 27 is an embodiment of the steps performed by three dimensional structure rendering and executing process 140-2 when it receives notification that the user 108 desires to view additional information.

In step 230, the three dimensional structure rendering and executing process 140-2 receives notification that the user 108 desires to view additional information. In an example embodiment, the user 108 interacts with a chosen panel (i.e., subset of image representations) 170-N within a close up view, and desires to view additional information associated with that chosen panel 170-N.

In step 231, the three dimensional structure rendering and executing process 140-2 receives notification that the user 108 has begun to scroll from viewing a third panel (i.e., subset of image representations) 170-22 to viewing a fourth panel (i.e., subset of image representations) 170-18 on the display 150. In an example embodiment, as shown in FIG. 11, when the user 108 is interacting with a chosen panel 170-22 in a close up view, the user 108 may indicate he/she wishes to view additional information in a variety of ways, for example, by beginning to scroll from the current panel 170-22 (that the user 108 is interacting with) to the next adjacent panel 170-18 within the three dimensional structure 165. The user 108 begins to scroll by dragging a finger across the display 150 at the location of the current panel 170-22.

In step 232, the three dimensional structure rendering and executing process 140-2 maintains the three dimensional structure 165 on the display 150 to orient the user 108 to an organization of the panels (i.e., subsets of image representations) 170-N within the three dimensional structure 165 when the user 108 begins to scroll from the third panel (i.e., subset of image representations) 170-22 to the fourth panel (i.e., subset of image representations) 170-18. In response to the user's 108 scrolling, the three dimensional structure rendering and executing process 140-2 renders both panels 170-22 and 170-18 on the display 150 while maintaining the three dimensional structure 165 on the display 150 as depicted in FIG. 11.

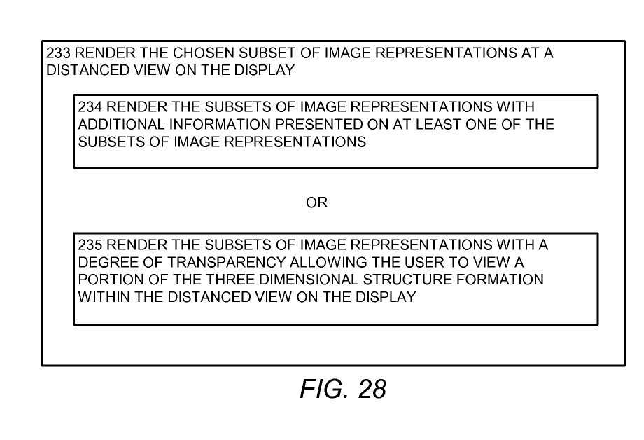

FIG. 28 is an embodiment of the steps performed by three dimensional structure rendering and executing process 140-2 when it renders the chosen panel (i.e., subset of image representations) 170-N at a distanced view on the display 150.

In step 233, the three dimensional structure rendering and executing process 140-2 renders the chosen panel (i.e., subset of image representations) 170-N at a distanced view on the display 150. FIGS. 9, 10 and 11 show example screen shots of panels 170-N rendered at a distanced view on the display 150.

In step 234, the three dimensional structure rendering and executing process 140-2 renders the panels (i.e., subsets of image representations) 170-N with additional information presented on at least one of the subsets of image representations 170-N. FIG. 9 shows an example distanced view of a three dimensional screen shot of two panels 170-20 and 170-21 of the three dimensional structure 165 on the display 150. The distanced view allows the user 108 to view the panels 170-20 and 170-21 within the formation of the three dimensional structure 165. The distanced view also allows the user 108 to view additional information on each of the panels 170-20 and 170-21, such as title bars 180-1 and 180-2. The title bars 180-1 and 180-2 provide the user 108 with additional information regarding the image representations 130-28, 130-29, 130-30, 130-31, 130-32, and 130-33 associated with each panel 170-20 and 170-21.

In step 235, the three dimensional structure rendering and executing process 140-2 renders the panels (i.e., subsets of image representations) 170-N with a degree of transparency allowing the user 108 to view a portion of the three dimensional structure 165 within the distanced view on the display 150. FIG. 10 shows an example distanced view of a three dimensional screen shot of two panels 170-11 and 170-19 of the three dimensional structure 165 rendered with a three dimensional graphic 120 on the display 150. The distanced view allows the user 108 to view the panels 170-11 and 170-19 within the formation of the three dimensional structure 165. The distanced view also allows the user 108 to view additional information on each of the panels 170-11 and 170-19, such as title bars 180-3 and 180-4. The title bars 180-3 and 180-4 provide the user 108 with additional information regarding the image representations 130-N contained within each panel 170-11 and 170-19. In this scenario, the panels 170-11 and 170-19 are rendered with transparency allowing the user 108 to view the three dimensional graphic 120 through the transparency. Viewing the three dimensional graphic 120 allows the user 108 to maintain the orientation of the panels 170-11 and 170-19 within the three dimensional structure 165.

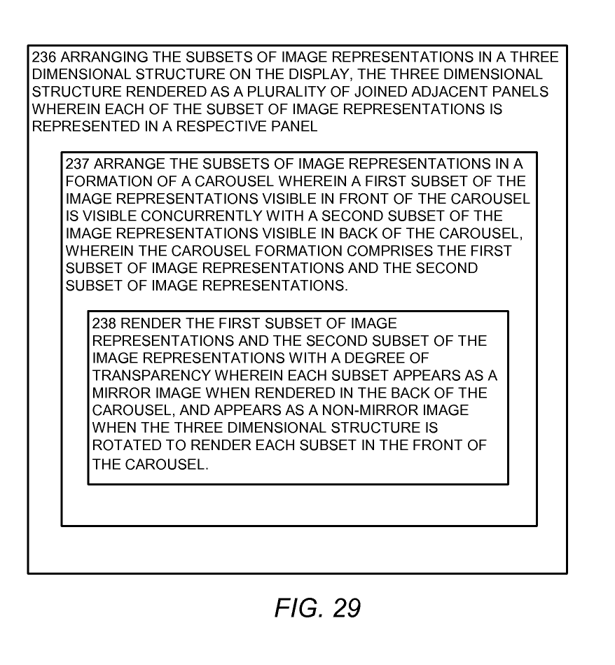

FIG. 29 is an embodiment of the steps performed by three dimensional structure rendering and executing process 140-2 when it arranges the subsets of image representations 170-N in a three dimensional structure 165 on the display 150.

In step 236, the three dimensional structure rendering and executing process 140-2 arranges the subsets of image representations 170-N in a three dimensional structure 165 on the display 150. The three dimensional structure 165 is rendered as a plurality of joined adjacent panels wherein each of the subset of image representations 170-N is represented in a respective panel.

In step 237, the three dimensional structure rendering and executing process 140-2 arranges the subsets of image representations 170-N in a formation of a carousel 165 (i.e., an example of a three dimensional structure 165) as depicted in FIG. 3. In the carousel 165 formation, a first subset of the image representations 170-7 visible in front of the carousel 165 is visible concurrently with a second subset of the image representations 170-3 visible in back of the carousel 165. The carousel 165 formation comprises both the first subset of image representations 170-7 and the second subset of image representations 170-3.

In step 238, the three dimensional structure rendering and executing process 140-2 renders the first subset of image representations 170-7 and the second subset of the image representations 170-3 (as depicted in FIG. 3) with a degree of transparency. Each subset appears as a mirror image when it is rendered in the back of the carousel 165 (i.e., an example of a three dimensional structure 165). Each subset appears as a non-mirror image when the carousel 165 is rotated to render each subset in the front of the carousel 165. In an example embodiment, each panel 170-N is transparent (i.e., capable of being viewed from either the back or the front of the panel 170-N). Thus, as the three dimensional structure is rotated, the user is viewing the back of those transparent panels 170-N, and the panels 170-N appear as mirror images when rendered in the back of the carousel. In FIG. 3 panels 170-2, 170-8, 170-3 and 170-4, located in the back of the three dimensional structure 165, are rendered on the display 150 as minor images whereas the panels 170-9 and 170-7 located in the front of the three dimensional structure 165 are rendered on the display 150 as non-mirror images. In other words, the user looks at the panels 170-9 and 170-7 located in the front of the three dimensional structure 165, and is able to read the wording on those panels 170-9 and 170-7 left to right. If the user 108 rotates the three dimensional structure 165 such that panels 170-2, 170-8, 170-3 and 170-4 are rotated to the front of the three dimensional structure 165, those panels (170-2, 170-8, 170-3 and 170-4) would appear as non-minor images and panels 170-9 and 170-7 would be rendered in the back of the three dimensional structure 165 and would appear as mirror images.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A method of presenting an organization of available applications within a communications device, the method comprising:
representing each of the available applications with a respective image representation on a display associated with the communications device;
associating each of the image representations with a respective subset of image representations, the subsets of image representations organized to assist a user to locate and interact with the image representations;
arranging the subsets of image representations in a three dimensional structure on the display, the three dimensional structure rendered as a plurality of joined adjacent panels wherein each of the subset of image representations is represented in a respective panel; and
allowing the user to access an available application within the three dimensional structure by manipulating the three dimensional structure three dimensionally, the available application accessed via the respective subset of image representations.

2. The method of claim 1 wherein arranging the subsets of image representations in a three dimensional structure on the display comprises:
arranging the subsets of image representations in a formation of a carousel wherein a first subset of the image representations visible in front of the carousel is visible concurrently with a second subset of the image representations visible in back of the carousel, wherein the carousel formation comprises the first subset of image representations and the second subset of image representations.

3. The method of claim 2 wherein arranging the subsets of image representations in a formation of a carousel comprises:
rendering the first subset of image representations and the second subset of the image representations with a degree of transparency wherein each subset appears as a minor image when rendered in the back of the carousel, and appears as a non-minor image when the three dimensional structure is rotated to render each subset in the front of the carousel.

4. The method of claim 1 wherein arranging the subsets of image representations in a formation of a three dimensional structure comprises:
rendering the three dimensional structure with a three dimensional graphic positioned along with the three dimensional structure on the display; and
positioning the graphic proportionally to a relative change in a position of the three dimensional structure when the three dimensional structure is manipulated by the user.

5. The method of claim 4 wherein rendering the three dimensional structure with a three dimensional graphic positioned along with the three dimensional structure on the display comprises:
animating the three dimensional graphic when positioned along with the three dimensional structure on the display.

6. The method of claim 4 wherein positioning the graphic proportionally to a relative change in a position of the three dimensional structure when the three dimensional structure is manipulated by the user comprises:
receiving notification that the user has modified the position of the three dimensional structure on the display; and
in response, simultaneously modifying a spatial position of the graphic to maintain an orientation of the graphic with respect to the relative change in the position of the three dimensional structure.

7. The method of claim 4 wherein positioning the graphic proportionally to a relative change in a position of the three dimensional structure when the three dimensional structure is manipulated by the user comprises:
modifying a size associated with a rendering of the graphic on the display, the size proportional to at least one subset of image representations rendered on the display.

8. The method of claim 7 comprising:
rendering the graphic on the display when a subset of image representations is rendered in a close up view on the display, the close up view allowing the user to interact with the image representations, the subset of image representations rendered with a degree of transparency, the graphic rendered to orient the user to a position associated with the subset of image representations within the three dimensional structure.

9. The method of claim 1 wherein allowing the user to access an available application within the three dimensional structure by manipulating the three dimensional structure three dimensionally comprises:
allowing the user to rotate the three dimensional structure on the display to view the subsets of image representations;
receiving a selection of a chosen subset of image representations from the user; and
rendering the chosen subset of image representations on the display to allow the user to interact with the image representations associated with the chosen subset of image representations.

10. The method of claim 9 comprising:
providing a mechanism to allow the user to toggle between any single subset of image representations and the three dimensional structure of subsets of image representations wherein a transition is performed seamlessly in an animated fashion on the display, the transition performed between rendering any single subset of image representations and rendering the three dimensional structure of subsets of image representations on the display, the transition comprising modification of a view rendered on the display from a close up view of any single subset of image representations to a distanced view of the plurality of subsets of image representations rendered on the display, the transition comprising creation of the three dimensional structure formed by connecting the plurality of subsets of image representations in a three dimensional fashion, the transition conveying to the user a connection between any single subset of image representations and the three dimensional structure of subsets of image representations.

11. The method of claim 9 wherein rendering the chosen subset of image representations on the display comprises:
rendering the chosen subset of image representations with a degree of transparency that allows a portion of the remaining subsets of image representations to remain visible on the display.

12. The method of claim 9 wherein rendering the chosen subset of image representations on the display comprises:
rendering the chosen subset of image representations in a close up view on the display to facilitate the user's interaction with the image representations;
receiving notification that the user desires to view additional information;
rendering the chosen subset of image representations at a distanced view on the display; and
allowing the user to manipulate the three dimensional structure of subsets of image representations within the distanced view on the display.

13. The method of claim 12 comprising:
receiving a selection of a subset of image representations within the distanced view on the display; and
rendering the subset of image representations in the close up view on the display to facilitate the user's interaction with the image representations.

14. The method of claim 12 comprising:
allowing the user to interact with at least one subset of image representations within the distanced view on the display.

15. The method of claim 12 wherein receiving notification that the user desires to view additional information comprises:
receiving notification that the user has begun to scroll from viewing a third subset of image representations to viewing a fourth subset of image representations on the display.

16. The method of claim 15 comprising:
maintaining the three dimensional structure on the display to orient the user to an organization of the subsets of image representations within the three dimensional structure when the user begins to scroll from the third subset of image representations to the fourth subset of image representations.

17. The method of claim 12 wherein rendering the chosen subset of image representations at a distanced view on the display comprises:
rendering the subsets of image representations with additional information presented on at least one of the subsets of image representations.

18. The method of claim 12 wherein rendering the chosen subset of image representations at a distanced view on the display comprises:
rendering the subsets of image representations with a degree of transparency allowing the user to view a portion of the three dimensional structure within the distanced view on the display.

19. A computerized device comprising:
a memory;
a processor;
a communications interface;
an interconnection mechanism coupling the memory, the processor and the communications interface;
wherein the memory is encoded with three dimensional structure rendering and executing application that when executed on the processor is capable of rendering and executing a three dimensional structure on the computerized device by performing the operations of:
representing each of the available applications with a respective image representation on a display associated with the communications device;
associating each of the image representations with a respective subset of image representations, the subsets of image representations organized to assist a user to locate and interact with the image representations;
arranging the subsets of image representations in a three dimensional structure t, on the display, the three dimensional structure rendered as a plurality of joined adjacent panels wherein each of the subset of image representations is represented in a respective panel; and
allowing the user to access an available application within the three dimensional structure by manipulating the three dimensional structure three dimensionally, the available application accessed via the respective subset of image representations.

20. A computer readable medium having computer readable code thereon, the medium comprising:
instructions for representing each of the available applications with a respective image representation on a display associated with the communications device;
instructions for associating each of the image representations with a respective subset of image representations, the subsets of image representations organized to assist a user to locate and interact with the image representations;
instructions for arranging the subsets of image representations in a three dimensional structure, on the display, the three dimensional structure rendered as a plurality of joined adjacent panels wherein each of the subset of image representations is represented in a respective panel; and
instructions for allowing the user to access an available application within the three dimensional structure by manipulating the three dimensional structure three dimensionally, the available application accessed via the respective subset of image representations.
